(19) United States
(12) Patent Application Publication
(10) Pub. No.: US 2026/0249466 A1
(43) Pub. Date: Aug. 27, 2026

(54) SYSTEM

(71) Applicant: SoftBank Group Corp., Tokyo (JP)

(72) Inventor: Haruna TAJIRI, Tokyo (JP)

(73) Assignee: SoftBank Group Corp., Tokyo (JP)

(21) Appl. No.: 19/537,519

(22) Filed: Feb. 12, 2026

(30) Foreign Application Priority Data
Feb. 21, 2025 (JP) 2025-027040

(51) Int. Cl. B25J 9/16

(52) U.S. Cl. CPC B25J 9/1674; B25J 9/1664; B25J 9/1676

(57) ABSTRACT

The system according to the embodiment comprises a scanning unit, an analysis unit, a robot arm, and a control unit. The scanning unit scans each page of a manual and stores it as digital data. The analysis unit analyzes data scanned by the scanning unit and generates wiring or furniture assembly procedures. The robot arm performs wiring or furniture assembly based on the procedures generated by the analysis unit. The control unit controls the operation of the robot arm.

### CROSS-REFERENCE TO RELATED APPLICATION

The present application claims priority to and incorporates by reference the entire contents of Japanese Patent Application No. 2025-027040 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that performing wiring or furniture assembly based on a manual is labor-intensive, making it difficult to carry out work efficiently.

### SUMMARY OF THE INVENTION

The system according to the embodiment comprises a scanning unit, an analysis unit, a robot arm, and a control unit. The scanning unit scans each page of a manual and stores it as digital data. The analysis unit analyzes data scanned by the scanning unit and generates wiring or furniture assembly procedures. The robot arm performs wiring or furniture assembly based on the procedures generated by the analysis unit. The control unit controls the operation of the robot arm.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

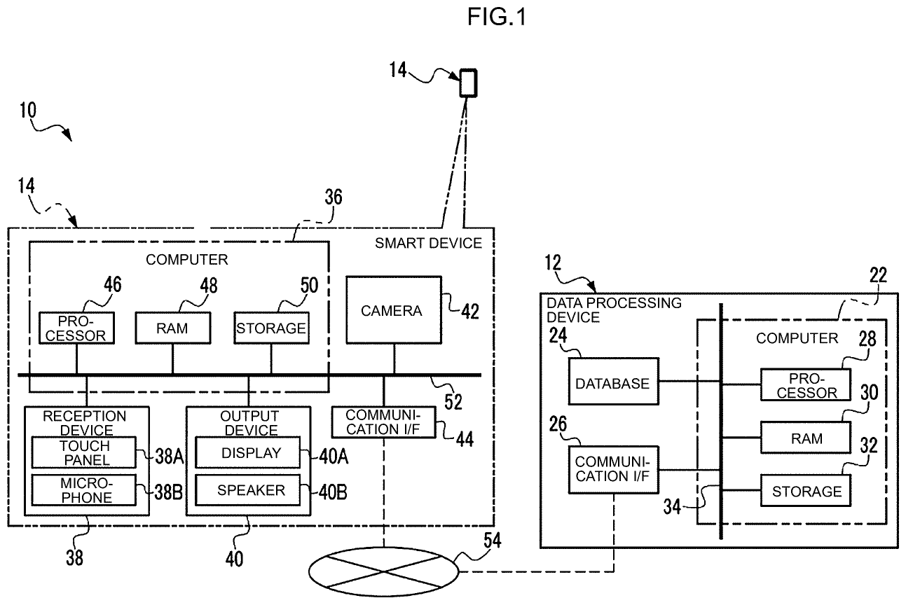

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

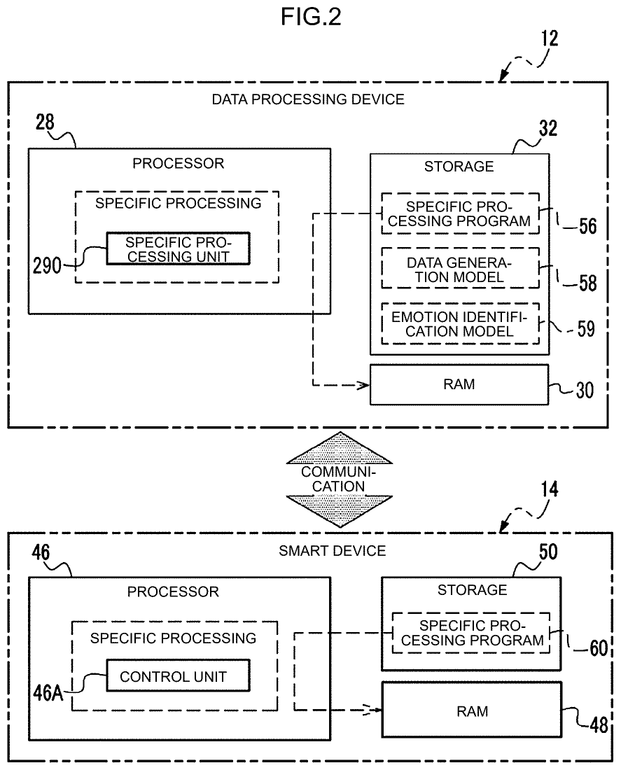

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system that, upon scanning a manual, automatically performs wiring and furniture assembly. In this system, the user scans the manual, and the scanned data is analyzed by AI to automatically generate wiring or furniture assembly procedures. Based on the generated procedures, a robot arm or automated machine performs the wiring or furniture assembly. As a result, the user can easily carry out complex wiring or furniture assembly tasks. For example, the user scans the manual, scanning each page and saving it as digital data. Next, the scanned data is analyzed by AI. The AI understands the content of the manual and automatically generates wiring or furniture assembly procedures, including, for example, the wiring connection order and the assembly order of furniture parts. Based on the generated procedures, the robot arm or automated machine performs the wiring or furniture assembly. The robot arm accurately connects wiring and assembles furniture parts according to the procedures generated by the AI. Thus, the user can easily perform complex wiring or furniture assembly tasks. With this system, the user can automate wiring and furniture assembly tasks simply by scanning the manual. For example, time-consuming tasks such as wiring new home appliances or assembling new furniture can be performed easily. Furthermore, since the AI analyzes the content of the manual, tasks are performed according to accurate procedures, reducing mistakes and improving work efficiency. Thus, by simply scanning the manual, wiring and furniture assembly tasks can be automated. Specifically, the system comprises multiple hardware and software modules, such as a scanning unit, analysis unit, robot arm, and control unit. The system scans each page of the manual at high resolution using the scanning unit and saves it as image data (e.g., RGB 600 dpi A4-size image tensor, three-dimensional array). The scanning unit automatically detects paper quality and printing condition, autonomously selects optimal resolution, contrast, and scanning speed. The analysis unit takes the scanned images as input, first using an image recognition module (e.g., convolutional neural networks such as ResNet or YOLO) to detect objects such as drawings, illustrations, part numbers, and wiring routes, and then using a natural language processing module (e.g., Transformer-based large language models) to tokenize, parse, and semantically analyze the manual text, associating images with text. The analysis unit integrates image feature vectors (e.g., 2048 dimensions) and text embedding vectors (e.g., 768 dimensions) to generate the logical structure of assembly procedures (e.g., directed graph format, with nodes representing parts and edges representing assembly order). Examples of AI input include (1) “A4-size manual image tensor (600×800×3)”, (2) “manual text token sequence (e.g., ‘Step1: Connect cable A to port B.’)”, and (3) “tabular data of parts list”. Examples of AI output include (1) “sequence of assembly procedure steps (e.g., [‘Step1: Insert screw X into hole Y’, ‘Step2: Attach panel Z’])”, (2) “graph structure data of wiring connection order”, and (3) “assembly action labels for each part”. The analysis unit transmits the output procedure data to the robot arm control unit. The robot arm sequentially executes actions such as gripping, positioning, connecting, and fastening each part based on the received procedure data. The robot arm obtains real-time feedback from force sensors and vision sensors and automatically corrects operation accuracy. The control unit records the operation history of the robot arm (e.g., time-series joint angle vectors, torque values, work success/failure flags) and applies automatic correction procedures using anomaly detection AI (e.g., time-series anomaly detection models) when errors occur. Through this series of processes, the system achieves high-precision and high-efficiency execution of complex assembly tasks that were difficult for humans, by multilayer integration of image, text, and sensor information, surpassing simple human automation. Technical effects of the system include (1) significant reduction in work time by automating assembly procedure generation, (2) prevention of assembly errors and reduction of work mistakes by AI, (3) flexible response to various manuals, parts, and wiring patterns, (4) continuous improvement of accuracy by accumulating work history, and (5) improved scalability through remote work instructions and cloud collaboration. Specific application fields include automatic assembly of home furniture, automation of wiring work on factory production lines, assembly support for medical devices, and emergency equipment installation at disaster sites. These technical details improve computer technology itself and provide novelty and inventive step beyond mere automation of human work.

The automatic assembly system according to the embodiment comprises a scanning unit, an analysis unit, a robot arm, and a control unit. The scanning unit scans each page of the manual and stores it as digital data. For example, the scanning unit scans each page of the manual with a high-resolution scanner and stores it as digital data. The scanning unit is equipped with functions to adjust scanning resolution and speed. For example, the scanning unit can automatically select optimal scanning settings according to the paper quality and printing condition of the manual. The analysis unit analyzes the data scanned by the scanning unit and generates wiring or furniture assembly procedures. For example, the analysis unit analyzes the content of the manual using image recognition technology and natural language processing. Image recognition technology recognizes drawings and illustrations in the manual, and natural language processing analyzes the text of the manual. For example, the analysis unit recognizes drawings in the manual and links them with text. The robot arm performs wiring or furniture assembly based on the procedures generated by the analysis unit. The robot arm is equipped with a connection unit for connecting wiring. The connection unit automates wiring connection work. For example, the connection unit is designed considering wiring connection methods and connection stability. The robot arm is equipped with an assembly unit for assembling furniture parts. The assembly unit automates furniture assembly work. For example, the assembly unit is designed considering furniture part assembly methods and assembly stability. The control unit controls the operation of the robot arm. For example, the control unit records the operation history of the robot arm and reflects it in the next operation. The control unit is equipped with a function to detect abnormalities during operation of the robot arm and automatically correct them. Thus, the automatic assembly system according to the embodiment can scan manuals and automate wiring or furniture assembly work. Specifically, the automatic assembly system is equipped with a high-resolution image sensor and image preprocessing circuit as the scanning unit, generating RGB image tensors (e.g., 600 dpi, 2480×3508×3) for each page of the manual. The scanning unit is equipped with a near-infrared sensor and thickness sensor for paper quality determination, and automatically sets optimal scanning parameters (resolution, exposure time, contrast correction value, etc.) according to the type and printing condition of the paper. The analysis unit detects drawings, illustrations, part numbers, and wiring routes using an image recognition module (e.g., convolutional neural networks, YOLOv5, etc.), tokenizes and semantically analyzes text using a natural language processing module (e.g., Transformer-based large language models), and links images with text. The analysis unit integrates image feature vectors (e.g., 2048 dimensions) and text embedding vectors (e.g., 768 dimensions) to generate a directed graph of assembly procedures (nodes: parts, edges: assembly order). The robot arm has a multi-joint structure with six or more degrees of freedom, and is equipped with a connection unit (wiring gripper with built-in torque sensor) and an assembly unit (end effector for gripping, positioning, and fastening parts). The robot arm sequentially executes gripping, moving, connecting, and fastening of each part according to procedure data (e.g., JSON format action list) received from the analysis unit. The control unit records joint angles, torque, force, and vision sensor data of the robot arm as time-series data, and applies automatic correction procedures using anomaly detection AI (e.g., LSTM-based time-series anomaly detection models) when errors occur. The control unit analyzes operation history and optimizes parameters for improved work efficiency in subsequent operations. With these configurations, the system achieves high-precision and high-efficiency execution of complex assembly tasks that were difficult for humans, by multilayer integration of image, text, and sensor information, surpassing simple human automation. Technical effects include (1) significant reduction in work time by automating assembly procedure generation, (2) prevention of assembly errors and reduction of work mistakes by AI, (3) flexible response to various manuals, parts, and wiring patterns, (4) continuous improvement of accuracy by accumulating work history, and (5) improved scalability through remote work instructions and cloud collaboration. Specific application fields include automatic assembly of home furniture, automation of wiring work on factory production lines, assembly support for medical devices, and emergency equipment installation at disaster sites.

The analysis unit can analyze the content of the manual using image recognition technology and natural language processing. Image recognition technology recognizes drawings and illustrations in the manual using techniques such as object detection and image classification. For example, the analysis unit recognizes drawings in the manual and links them with text. Natural language processing analyzes the text of the manual using techniques such as morphological analysis, grammatical analysis, and semantic analysis. For example, the analysis unit analyzes the content of the manual and generates wiring or furniture assembly procedures. Thus, the content of the manual can be accurately analyzed and wiring or furniture assembly procedures can be generated. Some or all of the above-described processing in the analysis unit may be performed using AI or without using AI. For example, the analysis unit can input manual data to a generative AI and have the generative AI perform the analysis. Specifically, the analysis unit takes high-resolution image tensors (e.g., 600 dpi, 2480×3508×3) received from the scanning unit as input, and first uses an image recognition module (convolutional neural networks such as ResNet or YOLOv5) to detect objects such as part drawings, wiring routes, illustrations, and symbols. The image recognition module performs object detection (bounding box output, e.g., ‘Part A: (x1,y1,x2,y2)’), image classification (e.g., ‘This is a screw’, ‘This is a cable’), etc. Next, the natural language processing module (Transformer-based large language model) tokenizes the manual text, performs morphological analysis (e.g., ‘Insert screw’→[‘screw’,‘insert’]), grammatical analysis (extraction of subject, predicate, object), and semantic analysis (extraction of procedure intent and conditional branches). The analysis unit integrates image feature vectors (e.g., 2048 dimensions) and text embedding vectors (e.g., 768 dimensions), and associates images with text (e.g., ‘Part A in FIG. 1 corresponds to Step 2 in the text’). Examples of AI input include (1) “A4-size manual image tensor”, (2) “manual text token sequence”, and (3) “tabular data of parts list”. Examples of AI output include (1) “sequence of assembly procedure steps (e.g., [‘Step1: Insert screw X’, ‘Step2: Attach panel Y’])”, (2) “graph structure data of wiring connection order”, and (3) “assembly action labels for each part”. The analysis unit transmits the output procedure data to the robot arm control unit for subsequent automatic assembly processing. These processes enable high-precision and high-speed integration analysis of diverse drawings, text, and procedures, which was difficult with conventional manual work or simple OCR, by leveraging AI's multilayer feature extraction and semantic understanding capabilities. Technical effects include (1) prevention of assembly errors by accurate analysis of manual content, (2) flexible response to various manual formats, (3) improved work efficiency by automating assembly procedure generation, and (4) improved efficiency of subsequent processing by structuring analysis results as data. Application fields include automatic assembly of home appliances, furniture, and industrial equipment, factory production lines, and assembly support for medical devices.

The robot arm may be equipped with a connection unit for connecting wiring. The connection unit is designed considering wiring connection methods and connection stability. For example, the connection unit automates wiring connection work. The connection unit precisely controls the force required for wiring connection and ensures connection stability. For example, the connection unit accurately aligns wiring connection parts and connects them with appropriate force. Thus, wiring connection work can be automated. Some or all of the above-described processing in the connection unit may be performed using AI or without using AI. For example, the connection unit can input wiring connection parts to a generative AI and have the generative AI perform the connection work. Specifically, the connection unit of the robot arm is equipped with multi-axis servo motors and high-precision encoders to achieve fine alignment of wiring terminals and connectors. The connection unit incorporates a force sensor (e.g., six-axis force torque sensor) to measure and control the required force in real time during each process such as insertion, crimping, and screwing of wiring. The connection unit inputs position and orientation data of wiring terminals (e.g., three-dimensional coordinate vectors) obtained from a vision sensor (e.g., 2D/3D camera) to AI (e.g., reinforcement learning-based motion planning model), which outputs optimal connection trajectories and force control parameters. Examples of AI input include (1) “image tensor of wiring terminals (e.g., 128×128×3)”, (2) “three-dimensional position vector of terminals (e.g., [x, y, z])”, and (3) “type label of connection target (e.g., ‘USB’, ‘LAN’, ‘power line’)”. Examples of AI output include (1) “trajectory parameters for connection operation (e.g., joint angle sequence)”, (2) “force control values (e.g., push force in Newtons)”, and (3) “connection completion judgment flag”. The connection unit cooperatively controls servo motors and grippers based on AI output to accurately grip, insert, and fix wiring terminals. As a subsequent process, after connection is completed, the connection state is rechecked with a vision sensor, and if an abnormality is detected, a readjustment operation is automatically executed. These processes enable high-precision and high-speed execution of fine alignment and force adjustment, which are difficult for manual work, by integrating AI and sensor feedback. Technical effects include (1) complete automation of wiring connection work, (2) significant reduction of connection mistakes and damage, (3) flexible response to various wiring standards and terminal shapes, and (4) continuous improvement of accuracy by accumulating work history. Application fields include automation of wiring for home appliances and industrial equipment, factory production lines, and wiring work for medical devices.

The robot arm may be equipped with an assembly unit for assembling furniture parts. The assembly unit is designed considering furniture part assembly methods and assembly stability. For example, the assembly unit accurately aligns furniture parts and assembles them with appropriate force. The assembly unit automates furniture assembly work. For example, the assembly unit accurately aligns furniture parts and assembles them with appropriate force. Thus, furniture assembly work can be automated. Some or all of the above-described processing in the assembly unit may be performed using AI or without using AI. For example, the assembly unit can input furniture part assembly sections to a generative AI and have the generative AI perform the assembly work. Specifically, the assembly unit of the robot arm is equipped with multi-joint servo motors and high-precision encoders to automate a series of operations such as gripping, moving, aligning, and fastening furniture parts. The assembly unit obtains the shape, position, and orientation of parts in real time using a vision sensor (e.g., 3D camera, depth sensor) and inputs them to AI (e.g., object recognition CNN+motion planning Transformer). Examples of AI input include (1) “3D point cloud data of parts (e.g., 100,000 points of [x,y,z] array)”, (2) “type label of parts (e.g., ‘top panel’, ‘leg’, ‘screw’)”, and (3) “step information of assembly procedure”. Examples of AI output include (1) “coordinates of gripping points and assembly positions (e.g., [x,y,z,roll,pitch,yaw])”, (2) “fastening force and torque values (e.g., in Newton-meters)”, and (3) “assembly completion judgment flag”. The assembly unit cooperatively controls servo motors and end effectors based on AI output to accurately align and fasten parts. After assembly is completed, the assembly state is rechecked with a vision sensor, and if an abnormality is detected, an automatic correction operation is executed. These processes enable high-precision alignment and force adjustment, which are difficult for manual work, by integrating AI and sensor feedback. Technical effects include (1) complete automation of furniture assembly work, (2) significant reduction of assembly mistakes and damage, (3) flexible response to various part shapes and assembly procedures, and (4) continuous improvement of accuracy by accumulating work history. Application fields include automatic assembly of home furniture, factory production lines, and assembly support for medical devices.

The control unit can control the operation of the robot arm. For example, the control unit records the operation history of the robot arm and reflects it in the next operation. The control unit is equipped with a function to detect abnormalities during operation of the robot arm and automatically correct them. For example, the control unit detects abnormalities during operation of the robot arm and executes correction procedures. The control unit analyzes the operation history of the robot arm and proposes efficient operations. Thus, the operation of the robot arm can be accurately controlled. Some or all of the above-described processing in the control unit may be performed using AI or without using AI. For example, the control unit can input the operation history of the robot arm to a generative AI and have the generative AI analyze the operation history. Specifically, the control unit records time-series data such as joint angles, torque, force, and vision sensor data of the robot arm (e.g., 100 samples per second, each sample is a 20-dimensional vector) in real time. The control unit inputs operation data to anomaly detection AI (e.g., LSTM-based time-series anomaly detection model) to detect deviations from normal patterns (e.g., sudden increase in joint torque, position misalignment). Examples of AI input include (1) “time-series vector of operation history (e.g., 1000 samples×20 dimensions)”, (2) “history of work success/failure flags”, and (3) “sensor data at the time of anomaly occurrence”. Examples of AI output include (1) “anomaly detection score (e.g., 0.95=95% probability of anomaly)”, (2) “correction operation pattern (e.g., re-gripping, re-alignment)”, and (3) “parameter optimization value for next work”. The control unit executes automatic correction procedures when an anomaly occurs based on AI output, and analyzes operation history to optimize parameters for improved work efficiency in subsequent operations during normal operation. These processes enable high-precision and high-speed optimization and anomaly correction of complex operation patterns, which are difficult with human heuristics or simple rule-based approaches, by leveraging AI's time-series analysis capabilities. Technical effects include (1) high-precision control of robot arm operation, (2) minimization of work interruption by automatic correction during anomaly occurrence, (3) continuous improvement of efficiency by accumulating operation history, and (4) improved adaptability to various work environments. Application fields include factory production lines, assembly support for medical devices, and remote operation robots.

The scanning unit can estimate the user's emotion and adjust the timing of scanning based on the estimated emotion of the user. For example, if the user is anxious, the scanning unit speeds up the timing to quickly acquire data. If the user is relaxed, the scanning unit slows down the timing to acquire data carefully. If the user feels uneasy, the scanning unit adjusts the timing to provide reassurance to the user. By adjusting the timing of scanning according to the user's emotion, more appropriate scanning can be achieved. Emotion estimation is realized using, for example, an emotion engine or generative AI with emotion estimation functions. The generative AI may be a text generation AI (e.g., LLM) or a multimodal generative AI, but is not limited to these examples. Some or all of the above-described processing in the scanning unit may be performed using AI or without using AI. For example, the scanning unit can input user emotion data to a generative AI and have the generative AI perform emotion estimation. Specifically, the scanning unit inputs multiple modalities such as user facial expression images (e.g., face image tensor 128×128×3), voice data (e.g., 3-second audio waveform), and biometric sensor data (e.g., heart rate, skin potential) to an emotion estimation AI (e.g., multimodal emotion recognition model). The AI integrates image features (e.g., facial action unit vectors), voice features (e.g., MFCC, pitch), and biometric features (e.g., heart rate variability) to output emotion labels (e.g., ‘anxious’, ‘relaxed’, ‘uneasy’) and emotion scores (e.g., ‘anxious:0.8, relaxed:0.1, uneasy:0.1’). Examples of AI input include (1) “face image tensor”, (2) “audio waveform data”, and (3) “biometric sensor values”. Examples of AI output include (1) “emotion label”, (2) “emotion score distribution”, and (3) “estimation confidence”. The scanning unit automatically adjusts the timing of scanning (e.g., immediate, after 3 seconds, after 10 seconds, etc.) based on AI output. As a subsequent process, the result of scan timing adjustment is fed back to the user interface to improve user reassurance and work efficiency. These processes enable objective and quantitative estimation of emotional states and optimization of scanning operations based on them, which are difficult with human subjective judgment. Technical effects include (1) flexible scan control according to the user's psychological state, (2) reduction of scan mistakes and user stress, and (3) improved adaptability to various user characteristics. Application fields include home scanners, work support in factories, and digitization of records in medical settings.

The scanning unit can automatically recognize the page order of the manual during scanning and store the digital data in the correct order. For example, the scanning unit recognizes page numbers and stores digital data in the correct order. The scanning unit analyzes the content of pages and automatically determines and stores the order. The scanning unit scans multiple pages at once and automatically organizes and stores them in order. By automatically recognizing the page order of the manual and storing digital data in the correct order, subsequent analysis becomes easier. Some or all of the above-described processing in the scanning unit may be performed using AI or without using AI. For example, the scanning unit can input scanned page data to a generative AI and have the generative AI perform page order recognition. Specifically, when scanning multiple pages of a manual at once, the scanning unit splits each page image tensor (e.g., RGB image at 600 dpi, 2480×3508×3) and uses an image recognition module (e.g., convolutional neural network) to extract features such as page numbers, header/footer positions, and font characteristics. Even when page numbers are missing or there are misbound or missing pages, the scanning unit analyzes text features of page content (e.g., chapter titles, headings, paragraph structure) and the order of appearance of figures and tables using a natural language processing module (e.g., Transformer-based large language model) to estimate logical page order. Examples of AI input include (1) “array of manual image tensors for multiple pages”, (2) “OCR text data for each page”, and (3) “position information of candidate page numbers”. Examples of AI output include (1) “reordering index sequence for page order (e.g., [3,1,2,4])”, (2) “confidence score for each page (e.g., ‘Page 1: 0.99, Page 2:0.95’)”, and (3) “warning label for pages with unknown order”. The scanning unit saves image and text data in the correct order based on AI output and seamlessly passes data to the subsequent analysis unit. As a subsequent process, the ordered data is used as input for assembly procedure generation AI and figure-text association AI, preventing analysis mistakes and erroneous assembly procedure generation due to incorrect page order. These processes enable high-precision and high-speed automatic recognition of page order for large numbers of pages, which is difficult with manual visual confirmation or manual reordering, by multilayer integration of image, text, and structural information. Technical effects of the scanning unit include (1) complete automation of page order recognition for reduced work time, (2) significant reduction of analysis mistakes due to order errors, (3) flexible response to missing page numbers and misbound pages, and (4) improved adaptability to various manual formats. Specific application fields include digitization of multi-page manuals for home appliances, furniture, and industrial equipment, manual management on factory production lines, and electronicization of procedure manuals for medical devices. These technical details improve computer technology itself, surpassing mere automation of human work.

The scanning unit can detect the paper quality and printing condition of the manual during scanning and automatically select appropriate scanning settings. For example, the scanning unit detects paper quality and automatically sets optimal resolution. The scanning unit detects printing condition and automatically sets optimal contrast and brightness. The scanning unit detects paper thickness and automatically sets optimal scanning speed. By automatically selecting optimal scanning settings according to the paper quality and printing condition of the manual, scanning quality is improved. Some or all of the above-described processing in the scanning unit may be performed using AI or without using AI. For example, the scanning unit can input data on paper quality and printing condition to a generative AI and have the generative AI select optimal scanning settings. Specifically, at the start of scanning, the scanning unit measures the type of paper (e.g., high-quality paper, recycled paper, coated paper, etc.) and thickness (e.g., 0.08 mm to 0.2 mm) using a near-infrared sensor and thickness sensor, and extracts printing condition (e.g., ink density, contrast, print unevenness, aging deterioration) from image tensors (e.g., 600 dpi, 2480×3508×3) using an image preprocessing circuit. The scanning unit inputs these physical and image features to AI (e.g., convolutional neural network+decision tree regression model) to infer optimal scanning parameters (e.g., resolution, exposure time, contrast correction value, scanning speed). Examples of AI input include (1) “paper quality sensor value vector (e.g., thickness, reflectance, fiber density)”, (2) “printing condition image features (e.g., histogram, edge strength)”, and (3) “past scan history data”. Examples of AI output include (1) “recommended scan resolution (e.g., 300 dpi, 600 dpi)”, (2) “contrast/brightness correction value (e.g., +15%)”, and (3) “scan speed setting (e.g., 10 pages/min)”. The scanning unit automatically adjusts scanner hardware settings based on AI output and performs scanning at optimal image quality and speed. As a subsequent process, the improved image data enhances the input accuracy of image recognition AI and text extraction AI in the analysis unit, greatly reducing errors in assembly procedure generation and the need for re-scanning. These processes enable high-precision and high-speed real-time adaptation to diverse paper qualities and printing conditions, which are difficult with human experience or manual settings, by integrating sensors, images, and AI. Technical effects of the scanning unit include (1) reduction of rework by automatic optimization of scan quality, (2) flexible response to diverse paper qualities and printing conditions, (3) compatibility of scan speed and image quality, and (4) improved accuracy of subsequent AI analysis. Application fields include electronicization of factory manuals, digitization of medical records, and preservation of old documents. These technical details fundamentally improve computer technology.

The scanning unit can estimate the user's emotion and adjust the scanning resolution based on the estimated emotion of the user. For example, if the user is anxious, the scanning unit performs rapid scanning at low resolution. If the user is relaxed, the scanning unit performs careful scanning at high resolution. If the user feels uneasy, the scanning unit performs balanced scanning at medium resolution. By adjusting the scanning resolution according to the user's emotion, more appropriate scanning can be achieved. Emotion estimation is realized using, for example, an emotion engine or generative AI with emotion estimation functions. The generative AI may be a text generation AI (e.g., LLM) or a multimodal generative AI, but is not limited to these examples. Some or all of the above-described processing in the scanning unit may be performed using AI or without using AI. For example, the scanning unit can input user emotion data to a generative AI and have the generative AI perform emotion estimation. Specifically, the scanning unit inputs multiple modalities such as user facial expression images (e.g., face image tensor 128×128×3), voice data (e.g., 3-second audio waveform), and biometric sensor data (e.g., heart rate, skin potential) to an emotion estimation AI (e.g., multimodal emotion recognition model). The AI integrates image features (e.g., facial action unit vectors), voice features (e.g., MFCC, pitch), and biometric features (e.g., heart rate variability) to output emotion labels (e.g., ‘anxious’, ‘relaxed’, ‘uneasy’) and emotion scores (e.g., ‘anxious:0.8, relaxed:0.1, uneasy:0.1’). Examples of AI input include (1) “face image tensor”, (2) “audio waveform data”, and (3) “biometric sensor values”. Examples of AI output include (1) “emotion label”, (2) “emotion score distribution”, and (3) “estimation confidence”. The scanning unit automatically adjusts the scanning resolution (e.g., 200 dpi, 600 dpi, 1200 dpi, etc.) based on AI output, achieving both optimal scan quality and speed according to the user's psychological state. As a subsequent process, the result of scan resolution adjustment is fed back to the user interface to improve user reassurance and work efficiency. These processes enable objective and quantitative estimation of emotional states and optimization of scanning operations based on them, which are difficult with human subjective judgment. Technical effects include (1) flexible scan quality control according to user psychology, (2) reduction of scan mistakes and user stress, and (3) improved adaptability to various user characteristics. Application fields include home scanners, work support in factories, and digitization of records in medical settings. These technical details improve computer technology.

The scanning unit can automatically recognize the language of the manual during scanning and select appropriate language settings. For example, the scanning unit recognizes the language of the manual and automatically selects appropriate language settings. The scanning unit recognizes multiple languages and suggests appropriate language settings to the user. The scanning unit detects language changes and automatically switches language settings. By automatically recognizing the language of the manual and selecting appropriate language settings, analysis accuracy is improved. Some or all of the above-described processing in the scanning unit may be performed using AI or without using AI. For example, the scanning unit can input manual language data to a generative AI and have the generative AI perform language recognition. Specifically, the scanning unit inputs text data extracted from scanned images (e.g., OCR result token sequence) to a natural language processing AI (e.g., multilingual Transformer model) to perform language identification (e.g., Japanese, English, Chinese, etc.) for each page or paragraph. Examples of AI input include (1) “OCR text data for each page”, (2) “list of candidate languages”, and (3) “history of past language settings”. Examples of AI output include (1) “language label for each page (e.g., ‘Page1: Japanese’, ‘Page2: English’)”, (2) “index of language switch points”, and (3) “language recognition confidence score”. The scanning unit automatically switches language settings for the analysis unit and user interface based on AI output, providing the user with the optimal language environment. As a subsequent process, the language recognition result enhances the input accuracy of text analysis AI and assembly procedure generation AI, preventing analysis mistakes in multilingual manuals and internationalized manuals. These processes enable high-precision and high-speed automatic recognition of multilingual and language switching, which are difficult with manual visual confirmation or manual settings, by leveraging AI's multilingual feature extraction capabilities. Technical effects of the scanning unit include (1) automatic response to multilingual manuals, (2) improved analysis accuracy, (3) improved usability, and (4) enhanced adaptability to internationally deployed products. Application fields include electronicization of global appliance and industrial equipment manuals, digitization of international conference materials, and management of multilingual procedure manuals for medic al devices. These technical details improve computer technology.

The scanning unit can detect the size and shape of the manual during scanning and select appropriate scanning methods. For example, the scanning unit detects the size of the manual and automatically selects the optimal scanning method. he scanning unit detects the shape of the manual and automatically selects the optimal scanning method. The scanning unit detects folds and bends in the manual and automatically selects the optimal scanning method. By selecting the optimal scanning method according to the size and shape of the manual, scanning quality is improved. Some or all of the above-described processing in the scanning unit may be performed using AI or without using AI. For example, the scanning unit can input data on the size and shape of the manual to a generative AI and have the generative AI select the optimal scanning method. Specifically, the scanning unit detects the outline and size (e.g., A4, B5, A3, etc.) and shape (e.g., rectangle, square, presence of folds or bends) of the manual using contour extraction AI (e.g., U-Net-based segmentation model) from the scanned image. Examples of AI input include (1) “scan image tensor”, (2) “contour coordinate data”, and (3) “features of folds and bends”. Examples of AI output include (1) “size label (e.g., ‘A4’, ‘B5’)”, (2) “shape classification label (e.g., ‘rectangle’, ‘with fold’)”, and (3) “optimal scanning method parameters (e.g., automatic trimming, bend correction, resolution setting)”. The scanning unit automatically applies scanner trimming range and image correction algorithms (e.g., geometric distortion correction, fold removal) based on AI output to achieve optimal image quality in digitization. As a subsequent process, image data optimized for size and shape enhances the input accuracy of image recognition AI and text extraction AI in the analysis unit, reducing misrecognition and the need for re-scanning. These processes enable high-precision and high-speed real-time adaptation to diverse sizes and shapes, which are difficult with manual visual confirmation or manual settings, by integrating images and AI. Technical effects of the scanning unit include (1) automatic optimization of scan quality, (2) flexible response to diverse sizes and shapes, (3) improved accuracy of subsequent AI analysis, and (4) reduction of rework. Application fields include electronicization of factory manuals, digitization of medical records, and preservation of manuals with special shapes. These technical details improve computer technology.

The analysis unit can estimate the user's emotion and determine the priority of analysis based on the estimated emotion of the user. For example, if the user is anxious, the analysis unit prioritizes analysis of important sections. If the user is relaxed, the analysis unit analyzes the entire manual evenly. If the user feels uneasy, the analysis unit prioritizes detailed analysis. By determining the priority of analysis according to the user's emotion, more appropriate analysis can be achieved. Emotion estimation is realized using, for example, an emotion engine or generative AI with emotion estimation functions. The generative AI may be a text generation AI (e.g., LLM) or a multimodal generative AI, but is not limited to these examples. Some or all of the above-described processing in the analysis unit may be performed using AI or without using AI. For example, the analysis unit can input user emotion data to a generative AI and have the generative AI perform emotion estimation. Specifically, the analysis unit inputs multiple modalities such as facial image tensor (e.g., 128×128×3), audio waveform data (e.g., 3-second audio sample), and biometric sensor values (e.g., heart rate, skin potential) to an emotion recognition AI (e.g., multimodal emotion recognition model). The analysis unit integrates image features (e.g., facial action unit vectors), audio features (e.g., MFCC, pitch), and biometric features (e.g., heart rate variability) using AI to output emotion labels (e.g., ‘anxious’, ‘relaxed’, ‘uneasy’) and emotion scores (e.g., ‘anxious:0.7, relaxed:0.2, uneasy:0.1’). Examples of AI input include (1) “facial image tensor”, (2) “audio waveform data”, and (3) “biometric sensor values”. Examples of AI output include (1) “emotion label”, (2) “emotion score distribution”, and (3) “estimation confidence”. Based on the estimated emotion label and score, the analysis unit selects segments to be prioritized for analysis from manual data (e.g., image tensor, text token sequence, parts list, etc.). For example, if the user is anxious, the analysis unit extracts and analyzes in detail important steps directly related to safety and work initiation (e.g., power wiring, assembly of main parts) using the image recognition module (e.g., YOLOv5) and natural language processing module (e.g., Transformer-based large language model). If the user is relaxed, the analysis unit evenly analyzes all chapters and items and generates comprehensive procedures. If the user feels uneasy, the analysis unit analyzes in detail sections with high risk of error (e.g., complex wiring, assembly of special parts) and enhances supplementary explanations and warnings. The analysis unit outputs prioritized analysis results as structured data (e.g., prioritized procedure list, action labels with importance scores) and transmits them to the subsequent robot arm control unit or user interface. As a subsequent process, the robot arm sequentially executes procedures with higher priority, and the user is presented with analysis results adapted to their emotional state (e.g., emphasis on key points, addition of detailed explanations). These processes enable high-precision and high-speed control of analysis priority according to user psychological state, which is difficult with human subjective judgment or simple rule-based approaches, by leveraging AI's multilayer feature extraction and decision-making algorithms. Technical effects of the analysis unit include (1) flexible control of analysis priority according to user psychology, (2) prevention of overlooking important sections, (3) improved user satisfaction and work efficiency, and (4) enhanced adaptability to various user characteristics. Specific application fields include assembly support for home furniture, optimization of work instructions on factory production lines, safety procedure analysis for medical devices, and emergency equipment installation support at disaster sites. These technical details improve computer technology itself, surpassing mere automation of human work.

The analysis unit can segment the content of the manual during analysis and perform detailed analysis for each segment. For example, the analysis unit segments the content of the manual and performs detailed analysis for each segment. The analysis unit segments the manual by chapter and performs detailed analysis for each chapter. The analysis unit segments the manual by item and performs detailed analysis for each item. By segmenting the content of the manual and performing detailed analysis for each segment, analysis accuracy is improved. Some or all of the above-described processing in the analysis unit may be performed using AI or without using AI. For example, the analysis unit can input the content of the manual to a generative AI and have the generative AI perform segmentation and detailed analysis. Specifically, the analysis unit inputs manual image tensors (e.g., 600 dpi, 2480×3508×3) and OCR text data received from the scanning unit to a natural language processing AI (e.g., Transformer-based large language model) to automatically extract logical structures such as chapters, sections, items, and procedures, and assign indexes to each segment. The analysis unit detects visual elements such as drawings, illustrations, tables, and flowcharts using an image recognition AI (e.g., convolutional neural network) and associates them with text segments. Examples of AI input include (1) “array of manual image tensors”, (2) “OCR text data”, and (3) “list of candidate chapters and items”. Examples of AI output include (1) “segmented text blocks (e.g., token sequence for each chapter, section, item)”, (2) “correspondence information for drawings and tables for each segment”, and (3) “analysis priority score for each segment”. The analysis unit performs detailed analysis such as image recognition, semantic analysis, and procedure extraction for each segment and generates assembly procedures and cautions as structured data for each segment. As a subsequent process, the robot arm control unit and user interface refer to analysis results for each segment to execute divided work procedures and provide stepwise instructions to the user. These processes enable high-precision analysis of the logical structure and segment-level details of large and complex manuals, which are difficult with manual work or simple full-text analysis, by leveraging AI's multilayer feature extraction and logical structure estimation capabilities. Technical effects of the analysis unit include (1) reduction of misrecognition and misanalysis by detailed analysis at the segment level, (2) flexible response to large and complex manuals, (3) improved efficiency of subsequent processing, and (4) improved usability. Specific application fields include automatic analysis of multi-chapter manuals for home appliances, furniture, and industrial equipment, divided work instructions on factory production lines, and procedure manual analysis for medical devices. These technical details improve computer technology.

The analysis unit can automatically recognize drawings and illustrations in the manual during analysis and link them with text. For example, the analysis unit recognizes drawings in the manual and links them with text. The analysis unit recognizes illustrations in the manual and links them with text. The analysis unit recognizes drawings and illustrations in the manual and links them with text. By automatically recognizing drawings and illustrations in the manual and linking them with text, analysis accuracy is improved. Some or all of the above-described processing in the analysis unit may be performed using AI or without using AI. For example, the analysis unit can input data on drawings and illustrations in the manual to a generative AI and have the generative AI perform recognition and linking. Specifically, the analysis unit inputs manual image tensors (e.g., 600 dpi, 2480×3508×3) obtained from the scanning unit to an image recognition AI (e.g., YOLOv5 or ResNet convolutional neural networks) to automatically detect objects such as drawings, illustrations, part symbols, and wiring routes. The analysis unit extracts bounding box coordinates and labels (e.g., ‘Part A’, ‘screw’, ‘cable’) of detected objects and associates them with token sequences of manual text using a natural language processing AI (e.g., Transformer-based large language model). Examples of AI input include (1) “manual image tensor”, (2) “candidate regions for drawings and illustrations”, and (3) “text token sequence”. Examples of AI output include (1) “label and position information for each drawing and illustration”, (2) “index for linking drawings and text (e.g., ‘FIG. 1 corresponds to Step 2’)”, and (3) “confidence score for drawing-text linking”. The analysis unit generates structured data (e.g., mapping table of figure numbers and procedure steps) for drawing and text linking information and transmits it to the subsequent assembly procedure generation AI and robot arm control unit. As a subsequent process, the robot arm executes accurate part gripping, positioning, and assembly operations based on drawings and illustrations, and the user is presented with procedure explanations and cautions linked to figures. These processes enable high-precision and high-speed automatic linking of large and complex drawings and text, which are difficult with manual visual confirmation or manual linking, by leveraging AI's multilayer feature extraction and semantic analysis capabilities. Technical effects of the analysis unit include (1) significant improvement of analysis accuracy by drawing-text linking, (2) reduction of assembly errors and procedure mistakes, (3) flexible response to various manual formats, and (4) improved accuracy of subsequent robot operations. Specific application fields include analysis of illustrated manuals for home appliances, furniture, and industrial equipment, visual work instructions on factory production lines, and analysis of illustrated procedure manuals for medical devices. These technical details improve computer technology.

The analysis unit can estimate the user's emotion and adjust the display method of analysis results based on the estimated emotion of the user. For example, if the user is nervous, the analysis unit provides a simple and highly visible display method. If the user is relaxed, the analysis unit provides a display method including detailed information. If the user is in a hurry, the analysis unit provides a display method focusing on key points. By adjusting the display method of analysis results according to the user's emotion, more appropriate display can be achieved. Emotion estimation is realized using, for example, an emotion engine or generative AI with emotion estimation functions. The generative AI may be a text generation AI (e.g., LLM) or a multimodal generative AI, but is not limited to these examples. Some or all of the above-described processing in the analysis unit may be performed using AI or without using AI. For example, the analysis unit can input user emotion data to a generative AI and have the generative AI perform emotion estimation. Specifically, the analysis unit inputs user facial expression images (e.g., face image tensor 128×128×3), audio waveform data (e.g., 3 seconds of audio), and biometric sensor values (e.g., heart rate, skin potential) to an emotion recognition AI (e.g., multimodal emotion recognition model) to output emotion labels (e.g., ‘nervous’, ‘relaxed’, ‘in a hurry’) and emotion scores (e.g., ‘nervous:0.6, relaxed:0.3, in a hurry:0.1’). Examples of AI input include (1) “face image tensor”, (2) “audio waveform data”, and (3) “biometric sensor values”. Examples of AI output include (1) “emotion label”, (2) “emotion score distribution”, and (3) “estimation confidence”. Based on the estimated emotion label and score, the analysis unit automatically adjusts the display method of analysis results (e.g., UI layout, amount of information, emphasis, color design, etc.). For example, if the user is nervous, only important procedures are displayed in large font and clear colors, omitting unnecessary information. If the user is relaxed, detailed procedure explanations, supplementary information, and illustrations are displayed abundantly. If the user is in a hurry, only key points are presented concisely in bullet points or icons. The analysis unit outputs the result of display method adjustment to the user interface, realizing optimal information presentation according to the user's psychological state. As a subsequent process, the user receives analysis results in the optimal amount and format according to their emotional state, improving work efficiency and reassurance. These processes enable high-precision and high-speed emotion-adaptive information presentation, which is difficult with human subjective judgment or manual UI settings, by leveraging AI's multilayer feature extraction and decision-making algorithms. Technical effects of the analysis unit include (1) flexible information presentation according to user psychology, (2) prevention of information overload and oversight, (3) improved user satisfaction and work efficiency, and (4) enhanced adaptability to various user characteristics. Specific application fields include assembly support UI for home furniture, work instruction terminals in factories, procedure display systems for medical devices, and emergency equipment installation support at disaster sites. These technical details improve computer technology.

The analysis unit can compare the content of the manual with other related documents during analysis and extract differences and commonalities. For example, the analysis unit compares the content of the manual with other related documents and extracts differences. The analysis unit compares the content of the manual with other related documents and extracts commonalities. The analysis unit compares the content of the manual with other related documents and extracts differences and commonalities. By comparing the content of the manual with other related documents and extracting differences and commonalities, analysis accuracy is improved. Some or all of the above-described processing in the analysis unit may be performed using AI or without using AI. For example, the analysis unit can input the content of the manual and data of other related documents to a generative AI and have the generative AI perform comparison and extraction. Specifically, the analysis unit inputs manual text data (e.g., token sequence, text blocks for each chapter and item) obtained from the scanning unit and comparison target documents (e.g., previous versions, manuals of other companies' products, specification documents, etc.) obtained from a related document database to a natural language processing AI (e.g., Transformer-based multi-document comparison model). Examples of AI input include (1) “manual text token sequence”, (2) “comparison target document token sequence”, and (3) “comparison target segment index”. Examples of AI output include (1) “list of differences (e.g., added, deleted, or changed steps)”, (2) “list of commonalities (e.g., identical procedures, identical part descriptions)”, and (3) “difference emphasis index”. The analysis unit visualizes differences between the manual and related documents based on AI output and extracts important changes and common procedures as structured data. As a subsequent process, the robot arm control unit and user interface refer to difference information to highlight changes in work procedures or utilize common procedures in automated processing. These processes enable high-precision extraction of differences and commonalities between large and complex documents, which are difficult with manual work or simple full-text comparison, by leveraging AI's multilayer feature extraction and semantic comparison capabilities. Technical effects of the analysis unit include (1) prevention of work mistakes by automatic extraction of differences and commonalities between documents, (2) efficient confirmation of version management and regulatory compliance, (3) improved accuracy of subsequent automated processing, and (4) flexible response to various document formats. Specific application fields include version management of manuals for home appliances, furniture, and industrial equipment, management of work procedure changes in factories, and confirmation of regulatory compliance for medical devices. These technical details improve computer technology.

The analysis unit can match the content of the manual with a cloud database during analysis and reflect the latest information. For example, the analysis unit matches the content of the manual with a cloud database and reflects the latest information. The analysis unit matches the content of the manual with a cloud database and reflects update information. The analysis unit matches the content of the manual with a cloud database and reflects the latest technical information. By matching the content of the manual with a cloud database and reflecting the latest information, analysis accuracy is improved. Some or all of the above-described processing in the analysis unit may be performed using AI or without using AI. For example, the analysis unit can input the content of the manual and data from the cloud database to a generative AI and have the generative AI perform matching and information reflection. Specifically, the analysis unit links manual text data (e.g., token sequence, text blocks for each chapter and item) obtained from the scanning unit with a cloud-based technical information database (e.g., latest product specifications, parts list, work procedures, regulatory information, etc.) via API and inputs them to a natural language processing AI (e.g., Transformer-based knowledge integration model). Examples of AI input include (1) “manual text token sequence”, (2) “token sequence of latest information obtained from the cloud database”, and (3) “update history index”. Examples of AI output include (1) “list of differences between manual content and latest information”, (2) “automatically updated text reflecting update sections”, and (3) “confidence score for technical information”. The analysis unit automatically corrects and updates manual content with the latest technical information based on AI output, reducing the risk of proceeding with work according to incorrect procedures or outdated specifications. As a subsequent process, the robot arm control unit and user interface refer to analysis results reflecting the latest information to prevent errors in work procedures and parts selection. These processes enable high-precision and high-speed real-time response to large-scale and frequent information updates, which are difficult with manual work or manual updates, by integrating AI and cloud collaboration. Technical effects of the analysis unit include (1) prevention of work mistakes by automatic reflection of the latest information, (2) rapid response to regulatory and product specification changes, (3) improved accuracy of subsequent automated processing, and (4) flexible adaptation to various information sources. Specific application fields include automatic updating of manuals for home appliances, furniture, and industrial equipment, updating of work procedures in factories, and regulatory compliance for medical devices. These technical details improve computer technology.

The robot arm can estimate the user's emotion and adjust the operation speed of the robot arm based on the estimated emotion of the user. For example, if the user is anxious, the robot arm increases its operation speed. If the user is relaxed, the robot arm slows down its operation speed. If the user feels uneasy, the robot arm adjusts its operation speed to provide reassurance to the user. By adjusting the operation speed of the robot arm according to the user's emotion, more appropriate operation can be achieved. Emotion estimation is realized using, for example, an emotion engine or generative AI with emotion estimation functions. The generative AI may be a text generation AI (e.g., LLM) or a multimodal generative AI, but is not limited to these examples. Some or all of the above-described processing in the robot arm may be performed using AI or without using AI. For example, the robot arm can input user emotion data to a generative AI and have the generative AI perform emotion estimation. Specifically, the robot arm inputs multiple modalities such as user facial image tensor (e.g., 128×128×3), audio waveform data (e.g., 3-second audio sample), and biometric sensor values (e.g., heart rate, skin potential, respiration rate) to an emotion recognition AI (e.g., multimodal emotion recognition model, ResNet-based image feature extraction+Transformer-based integration model). The robot arm integrates image features (e.g., facial action unit vectors), audio features (e.g., MFCC, pitch, spectral energy), and biometric features (e.g., heart rate variability, skin potential changes) using AI to output emotion labels (e.g., ‘anxious’, ‘relaxed’, ‘uneasy’) and emotion scores (e.g., ‘anxious:0.7, relaxed:0.2, uneasy:0.1’). Examples of AI input include (1) “face image tensor 128×128×3”, (2) “audio waveform data (3 seconds)”, and (3) “biometric sensor value vector (heart rate, skin potential)”. Examples of AI output include (1) “emotion label (e.g., ‘anxious’)”, (2) “emotion score distribution (e.g., ‘anxious:0.8, relaxed:0.1, uneasy:0.1’)”, and (3) “estimation confidence (e.g., 0.95)”. The robot arm automatically adjusts operation speed parameters (e.g., joint angular velocity, acceleration, interval between operations) based on AI output. For example, if the user is anxious, the joint angular velocity is set to 1.5 times the normal speed to shorten the work cycle time. If the user is relaxed, the operation speed is reduced to 0.7 times, prioritizing smoothness and safety. If the user feels uneasy, the operation speed is adjusted stepwise, and before starting operation, the robot arm can provide warnings via voice or lights to enhance user reassurance. As a subsequent process, the robot arm feeds back the result of operation speed adjustment to the control unit and user interface, visualizing the current operation mode and speed for the user. These processes enable high-precision and high-speed control of operation speed according to user psychological state, which is difficult with human subjective judgment or simple rule-based approaches, by leveraging AI's multilayer feature extraction and decision-making algorithms. Technical effects of the robot arm include (1) flexible control of operation speed according to user psychology, (2) compatibility of work efficiency and safety, (3) reduction of user stress and risk of erroneous operation, and (4) enhanced adaptability to various user characteristics. Specific application fields include assembly support robots for home furniture, worker psychology-adaptive robots on factory production lines, assembly support for medical devices, and emergency equipment installation support at disaster sites. These technical details improve computer technology itself, surpassing mere automation of human work.

The robot arm is capable of automatically detecting the shape and material of parts during operation and selecting the optimal assembly method. For example, the robot arm detects the shape of a part and selects the optimal assembly method. The robot arm detects the material of a part and selects the optimal assembly method. The robot arm detects both the shape and material of a part and selects the optimal assembly method. By selecting the optimal assembly method according to the shape and material of the parts, assembly accuracy is improved. Some or all of the above-mentioned processes in the robot arm may be performed using AI, or may be performed without using AI. For example, the robot arm may input data on the shape and material of parts into a generative AI, and the generative AI may select the optimal assembly method. Specifically, at the start of assembly work, the robot arm scans the outline of a part using a vision sensor (e.g., 3D camera, RGB-D camera), and extracts shape feature quantities (e.g., point cloud data, contour vectors, volume/surface area parameters) using an image recognition AI (e.g., U-Net-based segmentation model or ResNet-based classification model). Furthermore, the robot arm inputs physical property data such as reflection spectra obtained from near-infrared spectroscopic sensors or tactile sensors, and hardness or elasticity values, into the AI to infer material classification (e.g., metal, resin, wood, rubber, etc.). Examples of AI input include: (1) “3D point cloud data of parts (e.g., an array of 100,000 [x, y, z] points)”, (2) “surface image tensor (e.g., 128×128×3)”, (3) “spectral reflection vector”, etc. Examples of AI output include: (1) “shape label (e.g., ‘cylinder’, ‘L-shape’, ‘plate’)”, (2) “material label (e.g., ‘aluminum’, ‘ABS resin’, ‘MDF’)”, (3) “recommended assembly method parameters (e.g., gripping point coordinates, fastening force, type of adhesive)”, etc. Based on the AI output, the robot arm automatically selects the gripping force of the servo motor and the type of end effector (e.g., suction pad, gripper, magnetic chuck), and executes the optimal assembly operation for each part (e.g., screwing, press-fitting, insertion, adhesion). As a subsequent process, after assembly is completed, the robot arm rechecks the assembly state using a vision sensor or force sensor, and performs automatic correction if any abnormality is detected. These processes greatly surpass conventional technology in that the AI autonomously performs integrated analysis of high-dimensional feature quantities and assembly optimization for each part, which is difficult with human heuristics or visual inspection. The technical effects are: (1) significant improvement in work accuracy and quality through automatic optimization of assembly methods according to part shape and material; (2) flexible response to various part variations; (3) reduction of assembly errors and part damage; and (4) continuous improvement of accuracy through accumulation of work history. Specific application fields include multi-variety assembly of home appliances, furniture, and industrial equipment; precision assembly of medical devices; assembly of aerospace parts with different materials; and temporary facility construction at disaster sites. Through these technical details, the present invention goes beyond mere automation of human work and brings about improvements in computer technology itself.

The robot arm is capable of detecting the position of parts in real time during operation and improving accuracy. For example, the robot arm detects the position of parts in real time and improves accuracy. The robot arm detects the position of parts in real time and improves assembly accuracy. The robot arm detects the position of parts in real time and improves connection accuracy. By detecting the position of parts in real time, assembly accuracy is improved. Some or all of the above-mentioned processes in the robot arm may be performed using AI, or may be performed without using AI. For example, the robot arm may input position data of parts into a generative AI, and the generative AI may perform position detection. Specifically, the robot arm acquires image data in real time from 3D vision sensors (e.g., stereo camera, ToF camera, RGB-D camera) or 2D cameras installed in the workspace, and estimates the position and orientation of parts (e.g., three-dimensional coordinates [x, y, z], rotation angles [roll, pitch, yaw]) with high accuracy using image recognition AI (e.g., object detection models such as YOLOv5 or Mask R-CNN). Furthermore, the robot arm can use time-series data analysis AI (e.g., LSTM-based tracking model) to continuously update position information, taking into account disturbances such as part movement, vibration, and workbench shaking. Examples of AI input include: (1) “RGB image tensor of the workspace (e.g., 640×480×3)”, (2) “depth image tensor (e.g., 640×480×1)”, (3) “history vector of part positions over several past frames”, etc. Examples of AI output include: (1) “current position and orientation vector for each part (e.g., [x, y, z, roll, pitch, yaw])”, (2) “position detection confidence score (e.g., 0.98)”, (3) “dynamic tracking index”, etc. Based on the AI output, the robot arm automatically corrects gripping points and assembly positions in real time, and automatically adjusts the motion trajectory of servo motors and end effectors. As a subsequent process, during assembly and connection operations, feedback from vision sensors and force sensors is sequentially input to the AI, and minute deviations or errors are immediately corrected to maximize assembly accuracy and connection quality. These processes realize high-precision and high-speed position detection and dynamic correction, which are difficult with human visual inspection or simple coordinate specification, through the multi-layered feature extraction and time-series analysis capabilities of AI. The technical effects are: (1) significant improvement in work accuracy and speed through complete automation of part position detection; (2) real-time adaptation to disturbances and errors; (3) flexible response to various part arrangements and work environments; and (4) reduction of assembly and connection errors. Specific application fields include high-speed assembly on factory production lines; precision alignment of medical devices; high-precision joining of aerospace parts; and temporary equipment installation at disaster sites. Through these technical details, the present invention goes beyond mere automation of human work and brings about improvements in computer technology itself.

The robot arm is capable of estimating the user's emotion and adjusting the operation order of the robot arm based on the estimated emotion. For example, if the user is anxious, the robot arm prioritizes the assembly of important parts. If the user is relaxed, the robot arm assembles all parts evenly. If the user feels uneasy, the robot arm prioritizes the assembly of detailed parts. By adjusting the operation order of the robot arm according to the user's emotion, more appropriate operation becomes possible. Emotion estimation is realized using, for example, an emotion engine or generative AI with emotion estimation functions. Generative AI may be a text generation AI (e.g., LLM) or a multimodal generative AI, but is not limited to these examples. Some or all of the above-mentioned processes in the robot arm may be performed using AI, or may be performed without using AI. For example, the robot arm may input the user's emotion data into a generative AI, and the generative AI may perform emotion estimation. Specifically, the robot arm inputs multiple modality data such as the user's facial image (e.g., face image tensor 128×128×3), voice waveform data (e.g., 3 seconds of audio), and biometric sensor values (e.g., heart rate, skin potential) into an emotion recognition AI (e.g., multimodal emotion recognition model), and outputs emotion labels (e.g., ‘anxiety’, ‘relaxation’, ‘uneasiness’) and emotion scores (e.g., ‘anxiety:0.7, relaxation:0.2, uneasiness:0.1’). Examples of AI input include: (1) “face image tensor”, (2) “voice waveform data”, (3) “biometric sensor values”, etc. Examples of AI output include: (1) “emotion label”, (2) “emotion score distribution”, (3) “estimation confidence”, etc. Based on the estimated emotion label or score, the robot arm automatically reconstructs the priority of assembly procedures. For example, if the user is anxious, the robot arm prioritizes major steps directly related to safety or work initiation (e.g., power wiring, assembly of main parts); if the user is relaxed, the robot arm proceeds evenly through all procedures; if the user feels uneasy, the robot arm analyzes high-risk or error-prone parts (e.g., complex wiring, assembly of special parts) in detail, enhances supplementary explanations and warnings, and prioritizes their assembly. The robot arm automatically generates the motion sequence of servo motors and end effectors based on the prioritized procedure list, and optimizes the operation order in real time. As a subsequent process, the result of operation order adjustment is fed back to the control unit or user interface, and the user is presented with progress displays and cautions according to their emotional state. These processes realize high-precision and high-speed control of operation order according to the user's psychological state, which is difficult with human subjective judgment or simple rule-based methods, through multi-layered feature extraction and decision-making algorithms of AI. The technical effects are: (1) flexible control of operation order according to user psychology; (2) prevention of overlooking important parts; (3) improvement of user satisfaction and work efficiency; and (4) enhanced adaptability to diverse user characteristics. Specific application fields include assembly support robots for home furniture, worker psychology-adaptive robots on factory production lines, assembly support for medical devices, and emergency equipment installation support at disaster sites. Through these technical details, the present invention goes beyond mere automation of human work and brings about improvements in computer technology itself.

The robot arm is capable of detecting the temperature and humidity of parts during operation and maintaining an optimal operating environment. For example, the robot arm detects the temperature of parts and maintains an optimal operating environment. The robot arm detects the humidity of parts and maintains an optimal operating environment. The robot arm detects both the temperature and humidity of parts and maintains an optimal operating environment. By maintaining the optimal operating environment according to the temperature and humidity of parts, assembly accuracy is improved. Some or all of the above-mentioned processes in the robot arm may be performed using AI, or may be performed without using AI. For example, the robot arm may input data on the temperature and humidity of parts into a generative AI, and the generative AI may maintain the optimal operating environment. Specifically, when gripping parts, the robot arm acquires physical quantities in real time from built-in temperature sensors (e.g., thermistor, infrared thermometer) and humidity sensors (e.g., capacitive humidity sensor), and inputs them into an environmental monitoring AI (e.g., time-series anomaly detection model or decision tree regression model). Examples of AI input include: (1) “surface temperature data of parts (e.g., in Celsius)”, (2) “ambient humidity data of parts (e.g., % RH)”, (3) “history vector of past environmental data”, etc. Examples of AI output include: (1) “optimal operating environment parameters (e.g., recommended temperature range, humidity range)”, (2) “environmental anomaly detection flag (e.g., excessive temperature, excessive humidity)”, (3) “operation control correction values (e.g., reduced operation speed, adjusted gripping force)”, etc. Based on the AI output, if the operating environment is outside the proper range, the robot arm automatically reduces work speed or corrects gripping and fastening force. Furthermore, if necessary, the robot arm can cooperate with air conditioning or heating/dehumidifying devices in the work area to optimize environmental parameters. As a subsequent process, the result of environmental parameter adjustment is fed back to the control unit or user interface, improving work quality and safety. These processes realize high-precision and high-speed real-time environmental adaptation, which is difficult with human visual inspection or heuristics, through integration of sensors, AI, and control. The technical effects are: (1) stabilization of assembly quality through automatic adaptation to temperature and humidity fluctuations; (2) reduction of part damage and defects; (3) flexible response to various work environments; and (4) continuous improvement of accuracy through accumulation of work history. Specific application fields include assembly of precision equipment, environmental management assembly of medical devices, hygienic assembly of food and pharmaceuticals, and environment-controlled assembly of aerospace parts. Through these technical details, the present invention goes beyond mere automation of human work and brings about improvements in computer technology itself.

The robot arm is capable of automatically adjusting the contact pressure of parts during operation to prevent damage. For example, the robot arm detects the contact pressure of parts and prevents damage. The robot arm automatically adjusts the contact pressure of parts to prevent damage. The robot arm adjusts the contact pressure of parts in real time to prevent damage. By automatically adjusting the contact pressure of parts, damage is prevented and assembly accuracy is improved. Some or all of the above-mentioned processes in the robot arm may be performed using AI, or may be performed without using AI. For example, the robot arm may input data on the contact pressure of parts into a generative AI, and the generative AI may perform adjustment of contact pressure. Specifically, the robot arm acquires contact pressure data in real time (e.g., pressing force in Newtons, fastening torque) from six-axis force sensors or torque sensors built into the end effector, and inputs it into a force control AI (e.g., reinforcement learning-based force control model or decision tree regression model). Examples of AI input include: (1) “time-series data of contact pressure (e.g., 100 samples×1 dimension)”, (2) “part material label (e.g., ‘aluminum’, ‘resin’)”, (3) “work history vector”, etc. Examples of AI output include: (1) “optimal contact pressure value (e.g., 2.5N)”, (2) “pressure adjustment parameters (e.g., pressing speed, fastening torque)”, (3) “damage risk warning flag”, etc. Based on the AI output, the robot arm automatically adjusts the control gain of the servo motor or end effector to maintain optimal contact pressure for each part. Furthermore, if abnormal pressure fluctuations or damage risk are detected during assembly, the robot arm immediately stops operation and automatically performs corrective actions such as re-gripping or re-alignment. As a subsequent process, the results of contact pressure adjustment and abnormality detection history are fed back to the control unit or user interface, improving work quality and safety. These processes realize high-precision and high-speed pressure control and damage prevention, which are difficult with human senses or heuristics, through integration of AI and sensor feedback. The technical effects are: (1) significant reduction of part damage through automatic optimization of contact pressure; (2) flexible response to various materials and shapes; (3) compatibility of assembly quality and work efficiency; and (4) continuous improvement of accuracy through accumulation of work history. Specific application fields include assembly of precision equipment, damage prevention assembly of medical devices, multi-material assembly of home appliances and furniture, and high-reliability assembly of aerospace parts. Through these technical details, the present invention goes beyond mere automation of human work and brings about improvements in computer technology itself.

The control unit is capable of estimating the user's emotion and adjusting the control algorithm based on the estimated emotion. For example, if the user is anxious, the control unit applies a control algorithm that prioritizes rapid operation. If the user is relaxed, the control unit applies a control algorithm that prioritizes careful operation. If the user feels uneasy, the control unit applies a control algorithm that prioritizes safety. By adjusting the control algorithm according to the user's emotion, more appropriate control becomes possible. Emotion estimation is realized using, for example, an emotion engine or generative AI with emotion estimation functions. Generative AI may be a text generation AI (e.g., LLM) or a multimodal generative AI, but is not limited to these examples. Some or all of the above-mentioned processes in the control unit may be performed using AI, or may be performed without using AI. For example, the control unit may input the user's emotion data into a generative AI, and the generative AI may perform emotion estimation. Specifically, the control unit inputs multiple modality data such as face image tensor (e.g., 128×128×3), voice waveform data (e.g., 3 seconds of audio samples), and biometric sensor values (e.g., heart rate, skin potential, respiration rate) into an emotion recognition AI (e.g., multimodal emotion recognition model, ResNet-based image feature extraction+Transformer-based integration model). The control unit integrates image features (e.g., facial action unit vectors), voice features (e.g., MFCC, pitch, spectral energy), and biometric features (e.g., heart rate variability, skin potential changes), and outputs emotion labels (e.g., ‘anxiety’, ‘relaxation’, ‘uneasiness’) and emotion scores (e.g., ‘anxiety:0.7, relaxation:0.2, uneasiness:0.1’). Examples of AI input include: (1) “face image tensor 128×128×3”, (2) “voice waveform data (3 seconds)”, (3) “biometric sensor value vector (heart rate, skin potential)”, etc. Examples of AI output include: (1) “emotion label (e.g., ‘anxiety’)”, (2) “emotion score distribution (e.g., ‘anxiety:0.8, relaxation:0.1, uneasiness:0.1’)”, (3) “estimation confidence (e.g., 0.95)”, etc. Based on the AI output, the control unit automatically switches the selection of control algorithms and parameters (e.g., PID control gain, operation speed, acceleration limit, error tolerance). For example, if the user is anxious, the control unit applies a high-speed response feedforward control or predictive control algorithm to minimize operation delay. If the user is relaxed, the control unit applies feedback control or fine position correction algorithms that emphasize smoothness and precision of operation. If the user feels uneasy, the control unit prioritizes safety, tightens abnormality detection thresholds, suppresses operation speed, and adds redundant safety confirmation procedures. As a subsequent process, the result of control algorithm switching is fed back to the robot arm or user interface, and the user is presented with the current control mode and safety status. These processes realize high-precision and high-speed dynamic optimization of control algorithms according to the user's psychological state, which is difficult with human subjective judgment or simple rule-based methods, through multi-layered feature extraction and decision-making algorithms of AI. The technical effects are: (1) flexible switching of control algorithms according to user psychology; (2) compatibility of work efficiency and safety; (3) reduction of user stress and risk of erroneous operation; and (4) enhanced adaptability to diverse user characteristics. Specific application fields include assembly support robots for home furniture, worker psychology-adaptive control on factory production lines, safety control of medical devices, and emergency equipment installation support at disaster sites. Through these technical details, the present invention goes beyond mere automation of human work and brings about improvements in computer technology itself.

The control unit is capable of recording the operation history of the robot arm and reflecting it in the next operation. For example, the control unit records the operation history of the robot arm and reflects it in the next operation. The control unit analyzes the operation history of the robot arm and proposes efficient operations. The control unit generates optimal operation patterns based on the operation history of the robot arm. By recording the operation history of the robot arm and reflecting it in the next operation, operation accuracy is improved. Some or all of the above-mentioned processes in the control unit may be performed using AI, or may be performed without using AI. For example, the control unit may input the operation history data of the robot arm into a generative AI, and the generative AI may analyze the operation history. Specifically, the control unit records time-series data such as joint angles, torque, force, and vision sensor data of the robot arm (e.g., 100 samples per second, each sample is a 20-dimensional vector) in real time. The control unit inputs the recorded operation history into a time-series analysis AI (e.g., LSTM-based time-series anomaly detection model or autoregressive prediction model) to extract normal patterns, abnormal patterns, and highly efficient operation sequences. Examples of AI input include: (1) “time-series vector of operation history (e.g., 1000 samples×20 dimensions)”, (2) “history of work success/failure flags”, (3) “sensor data at the time of abnormality occurrence”, etc. Examples of AI output include: (1) “optimal operation pattern (e.g., joint angle series, sequence of gripping, moving, fastening)”, (2) “efficiency improvement proposals (e.g., shortened operation steps, reduction of redundant operations)”, (3) “history analysis score (e.g., work success rate, abnormality occurrence rate)”, etc. Based on the AI output, the control unit automatically generates operation plans for subsequent operations and optimizes control parameters of the robot arm (e.g., operation speed, acceleration, gripping force, operation order). Furthermore, the control unit continuously learns from history data according to changes in work environment and part variations, and sequentially updates operation patterns. As a subsequent process, the optimized operation pattern is applied to the robot arm control module, improving work efficiency and accuracy. These processes realize high-precision and high-speed optimization and abnormality correction of complex operation patterns, which are difficult with human heuristics or simple rule-based methods, through the time-series analysis capability of AI. The technical effects are: (1) high-precision control of robot arm operation; (2) minimization of work interruption through automatic correction during abnormality occurrence; (3) continuous improvement of efficiency through accumulation of operation history; and (4) improved adaptability to various work environments. Specific application fields include factory production lines, assembly support for medical devices, and remote operation robots. Through these technical details, the present invention brings about improvements in computer technology.

The control unit may be provided with a function to detect abnormalities during operation of the robot arm and automatically correct them. For example, the control unit detects abnormalities during operation of the robot arm and automatically corrects them. The control unit detects abnormalities during operation of the robot arm and executes correction procedures. The control unit detects abnormalities during operation of the robot arm and corrects them in real time. By detecting abnormalities during operation of the robot arm and automatically correcting them, operation accuracy is improved. Some or all of the above-mentioned processes in the control unit may be performed using AI, or may be performed without using AI. For example, the control unit may input operation data of the robot arm into a generative AI, and the generative AI may perform abnormality detection and correction. Specifically, the control unit acquires time-series data such as joint angles, torque, force, and vision sensor data of the robot arm (e.g., 100 samples per second, each sample is a 20-dimensional vector) in real time, and inputs it into an anomaly detection AI (e.g., LSTM-based time-series anomaly detection model or autoencoder-based anomaly scoring model). The control unit detects deviations from normal patterns (e.g., sudden increase in joint torque, position deviation, abnormal fluctuation in gripping force) with high accuracy using AI, and immediately executes automatic correction procedures (e.g., re-gripping, re-alignment, operation interruption and resumption) when an abnormality occurs. Examples of AI input include: (1) “time-series vector of operation history (e.g., 1000 samples×20 dimensions)”, (2) “history of work success/failure flags”, (3) “sensor data at the time of abnormality occurrence”, etc. Examples of AI output include: (1) “anomaly detection score (e.g., 0.95=95% probability of anomaly)”, (2) “correction operation pattern (e.g., re-gripping, re-alignment)”, (3) “parameter optimization value for next work”, etc. Based on the AI output, the control unit executes automatic correction procedures when an abnormality occurs, and analyzes operation history during normal operation to optimize parameters for improving work efficiency in subsequent operations. Furthermore, the control unit accumulates anomaly detection and correction history, and continuously learns to optimize anomaly detection accuracy and correction algorithms. As a subsequent process, the results of anomaly detection and correction are fed back to the user interface or higher-level management system, improving work quality and safety. These processes realize high-precision and high-speed optimization and abnormality correction of complex operation patterns, which are difficult with human heuristics or simple rule-based methods, through the time-series analysis capability of AI. The technical effects are: (1) high-precision control of robot arm operation; (2) minimization of work interruption through automatic correction during abnormality occurrence; (3) continuous improvement of efficiency through accumulation of operation history; and (4) improved adaptability to various work environments. Specific application fields include factory production lines, assembly support for medical devices, and remote operation robots. Through these technical details, the present invention brings about improvements in computer technology.

The control unit is capable of estimating the user's emotion and adjusting control parameters based on the estimated emotion. For example, if the user is anxious, the control unit applies control parameters that prioritize rapid operation. If the user is relaxed, the control unit applies control parameters that prioritize careful operation. If the user feels uneasy, the control unit applies control parameters that prioritize safety. By adjusting control parameters according to the user's emotion, more appropriate control becomes possible. Emotion estimation is realized using, for example, an emotion engine or generative AI with emotion estimation functions. Generative AI may be a text generation AI (e.g., LLM) or a multimodal generative AI, but is not limited to these examples. Some or all of the above-mentioned processes in the control unit may be performed using AI, or may be performed without using AI. For example, the control unit may input the user's emotion data into a generative AI, and the generative AI may perform emotion estimation. Specifically, the control unit inputs multiple modality data such as face image tensor (e.g., 128×128×3), voice waveform data (e.g., 3 seconds of audio samples), and biometric sensor values (e.g., heart rate, skin potential, respiration rate) into an emotion recognition AI (e.g., multimodal emotion recognition model). The control unit integrates image features (e.g., facial action unit vectors), voice features (e.g., MFCC, pitch), and biometric features (e.g., heart rate variability), and outputs emotion labels (e.g., ‘anxiety’, ‘relaxation’, ‘uneasiness’) and emotion scores (e.g., ‘anxiety:0.7, relaxation:0.2, uneasiness:0.1’). Examples of AI input include: (1) “face image tensor”, (2) “voice waveform data”, (3) “biometric sensor values”, etc. Examples of AI output include: (1) “emotion label”, (2) “emotion score distribution”, (3) “estimation confidence”, etc. Based on the AI output, the control unit automatically adjusts control parameters (e.g., operation speed, acceleration, gripping force, error tolerance, number of redundant safety checks). For example, if the user is anxious, the control unit increases operation speed and acceleration to shorten the work cycle time. If the user is relaxed, the control unit suppresses operation speed and increases gripping force and alignment accuracy. If the user feels uneasy, the control unit tightens the number of safety checks and abnormality detection thresholds, and suppresses operation speed. As a subsequent process, the result of control parameter adjustment is fed back to the robot arm or user interface, and the user is presented with the current control mode and safety status. These processes realize high-precision and high-speed dynamic optimization of control parameters according to the user's psychological state, which is difficult with human subjective judgment or simple rule-based methods, through multi-layered feature extraction and decision-making algorithms of AI. The technical effects are: (1) flexible adjustment of control parameters according to user psychology; (2) compatibility of work efficiency and safety; (3) reduction of user stress and risk of erroneous operation; and (4) enhanced adaptability to diverse user characteristics. Specific application fields include assembly support robots for home furniture, worker psychology-adaptive control on factory production lines, safety control of medical devices, and emergency equipment installation support at disaster sites. Through these technical details, the present invention goes beyond mere automation of human work and brings about improvements in computer technology itself.

The control unit is capable of cooperating with other automation systems and controlling multiple tasks simultaneously. For example, the control unit cooperates with other automation systems and controls multiple tasks simultaneously. The control unit cooperates with other automation systems to achieve efficient work. The control unit cooperates with other automation systems to monitor the progress of work in real time. By cooperating with other automation systems and controlling multiple tasks simultaneously, work efficiency is improved. Some or all of the above-mentioned processes in the control unit may be performed using AI, or may be performed without using AI. For example, the control unit may input data from other automation systems into a generative AI, and the generative AI may perform cooperation and control. Specifically, the control unit collects real-time status data (e.g., work progress, error occurrence status, part inventory, transport route information, etc.) from multiple robot arms, transport devices, inspection devices, and other automation systems in a factory. The control unit integrates these diverse system data and inputs them into an AI (e.g., multi-agent reinforcement learning model or graph neural network). Examples of AI input include: (1) “state vector of each automation system (e.g., progress rate, operating status, error code)”, (2) “work schedule data”, (3) “resource allocation information”, etc. Examples of AI output include: (1) “work assignment optimization results (e.g., task instruction list for each robot)”, (2) “progress monitoring alerts (e.g., delay detection, bottleneck warning)”, (3) “cooperation control parameters (e.g., timing adjustment, priority setting)”, etc. Based on the AI output, the control unit automatically adjusts work assignment and timing among multiple automation systems to maximize overall work efficiency and throughput. Furthermore, in case of progress or abnormality occurrence, the control unit resets control parameters in real time to achieve flexible cooperation control. As a subsequent process, the result of cooperation control is fed back to each automation system or higher-level management system, maintaining overall optimization. These processes realize high-precision and high-speed cooperation among large-scale and complex systems, which are difficult with manual work or simple rule-based methods, through multi-layered feature extraction and decision-making algorithms of AI. The technical effects are: (1) significant improvement in work efficiency and throughput through cooperation among multiple automation systems; (2) real-time monitoring of progress and response to abnormalities; (3) cost reduction through resource optimization; and (4) flexible adaptation to various production lines and work environments. Specific application fields include overall control of factory production lines, automatic transport and sorting in logistics warehouses, multi-device cooperation control of medical equipment, and cooperative work of multiple robots at disaster sites. Through these technical details, the present invention brings about improvements in computer technology.

The control unit may be provided with an interface capable of remotely operating the robot arm. For example, the control unit provides an interface capable of remotely operating the robot arm. The control unit provides an application capable of remotely operating the robot arm. The control unit provides a web interface capable of remotely operating the robot arm. By providing an interface capable of remotely operating the robot arm, operational flexibility is improved. Some or all of the above-mentioned processes in the control unit may be performed using AI, or may be performed without using AI. For example, the control unit may input remote operation data into a generative AI, and the generative AI may execute the remote operation interface. Specifically, the control unit provides a web-based remote operation interface accessible via the Internet, or a dedicated application for smartphones and tablets. The control unit receives remote operation commands from the user in real time (e.g., joystick input, touch panel operation, voice instructions, preset operation selection, etc.), and sends command data (e.g., joint angle commands, operation sequences, gripping force settings, etc.) to the robot arm control module. Furthermore, the control unit streams the robot arm's operation status (e.g., camera images, sensor values, work progress) and provides feedback to the user. Examples of AI input include: (1) “remote operation command data (e.g., joystick values, voice commands)”, (2) “real-time video and sensor data”, (3) “user authentication information”, etc. Examples of AI output include: (1) “operation correction parameters (e.g., delay compensation, erroneous operation prevention)”, (2) “automatic safety monitoring flag”, (3) “user operation assist proposals”, etc. Based on the AI output, the control unit automatically compensates for communication delays and erroneous operation risks during remote operation, enhancing safety and operability. Furthermore, depending on the user's operation history and work status, the AI can automatically perform assist operations and issue warnings. As a subsequent process, the results of remote operation and safety monitoring information are fed back to the user interface or higher-level management system, improving work quality and safety. These processes realize high-precision and high-safety remote control, which are difficult with manual work or simple remote operation, through integration of AI and communication/control technology. The technical effects are: (1) high-precision and high-safety robot operation from remote locations; (2) reduction of communication delays and erroneous operation risks; (3) flexible response to diverse user environments; and (4) compatibility of work efficiency and safety. Specific application fields include remote maintenance and monitoring in factories, remote operation of medical devices, remote control of robots at disaster sites, and remote work support in space and marine fields. Through these technical details, the present invention brings about improvements in computer technology.

The system according to the embodiment is not limited to the above examples, and various modifications are possible, for example, as follows. Specifically, the system of the present invention can be variously modified in terms of the type of robot arm (e.g., articulated type, Cartesian type, SCARA type), sensor configuration (e.g., 3D camera, force sensor, temperature/humidity sensor), AI model architecture (e.g., CNN, Transformer, reinforcement learning model), and network configuration (e.g., edge AI, cloud cooperation, distributed control). The system may also adopt a configuration in which, according to the assembly target or work environment, it cooperates with other automation devices such as part supply devices, automatic transport robots, and inspection devices. Furthermore, by introducing transfer learning, online learning, or federated learning as AI model training methods, high-precision operation optimization adapted to site-specific data becomes possible. In addition, variations such as adding sensors and algorithms for emotion estimation, including gaze tracking, posture estimation, and EEG sensors, in addition to facial image, voice, and biometric information, are conceivable. Application fields include automatic assembly of home furniture, factory production lines, assembly support for medical devices, emergency equipment installation at disaster sites, and remote work support in space and marine fields, and the invention can be deployed in a wide range of uses. Through these diverse embodiments, the present invention goes beyond mere automation of human work and brings about improvements, novelty, and inventive step in computer technology itself.

The analysis unit is capable of estimating the user's emotion and determining the priority of analysis based on the estimated emotion. For example, if the user is anxious, the analysis unit prioritizes the analysis of important parts. If the user is relaxed, the analysis unit analyzes the entire content evenly. If the user feels uneasy, the analysis unit prioritizes detailed analysis. By determining the priority of analysis according to the user's emotion, more appropriate analysis becomes possible. Emotion estimation is realized using, for example, an emotion engine or generative AI with emotion estimation functions. Generative AI may be a text generation AI (e.g., LLM) or a multimodal generative AI, but is not limited to these examples. Some or all of the above-mentioned processes in the analysis unit may be performed using AI, or may be performed without using AI. For example, the analysis unit may input the user's emotion data into a generative AI, and the generative AI may perform emotion estimation. Specifically, the analysis unit inputs multiple modality data such as face image tensor (e.g., 128×128×3), voice waveform data (e.g., 3 seconds of audio samples), and biometric sensor values (e.g., heart rate, skin potential) into an emotion recognition AI (e.g., multimodal emotion recognition model). The analysis unit integrates image features (e.g., facial action unit vectors), voice features (e.g., MFCC, pitch), and biometric features (e.g., heart rate variability), and outputs emotion labels (e.g., ‘anxiety’, ‘relaxation’, ‘uneasiness’) and emotion scores (e.g., ‘anxiety:0.7, relaxation:0.2, uneasiness:0.1’). Examples of AI input include: (1) “face image tensor”, (2) “voice waveform data”, (3) “biometric sensor values”, etc. Examples of AI output include: (1) “emotion label”, (2) “emotion score distribution”, (3) “estimation confidence”, etc. Based on the estimated emotion label or score, the analysis unit selects segments to be prioritized for analysis from the instruction manual data (e.g., image tensor, text token sequence, parts list, etc.). For example, if the user is anxious, the analysis unit extracts important steps directly related to safety or work initiation (e.g., power wiring, assembly of main parts) from the assembly procedure, and performs detailed analysis using the image recognition module (e.g., YOLOv5) or natural language processing module (e.g., Transformer-based large language model). If the user is relaxed, the analysis unit analyzes all chapters and items evenly and generates comprehensive procedures. If the user feels uneasy, the analysis unit analyzes high-risk or error-prone parts (e.g., complex wiring, assembly of special parts) in detail and enhances supplementary explanations and warnings. The analysis unit outputs the prioritized analysis results as structured data (e.g., prioritized procedure list, action labels with importance scores), and sends them to the subsequent robot arm control unit or user interface. As a subsequent process, the robot arm sequentially executes procedures with high priority, and the user is presented with analysis results (e.g., emphasis on key points, addition of detailed explanations) according to their emotional state. These processes realize high-precision and high-speed control of analysis priority according to the user's psychological state, which is difficult with human subjective judgment or simple rule-based methods, through multi-layered feature extraction and decision-making algorithms of AI. The technical effects are: (1) flexible control of analysis priority according to user psychology; (2) prevention of overlooking important parts; (3) improvement of user satisfaction and work efficiency; and (4) enhanced adaptability to diverse user characteristics. Specific application fields include assembly support for home furniture, optimization of work instructions on factory production lines, safety procedure analysis for medical devices, and emergency equipment installation support at disaster sites. Through these technical details, the present invention goes beyond mere automation of human work and brings about improvements in computer technology itself.

The scanning unit is capable of automatically recognizing the page order of a manual during scanning and storing the digital data in the correct order. For example, the scanning unit recognizes page numbers and stores digital data in the correct order. The scanning unit analyzes the content of pages and automatically determines and stores the order. The scanning unit scans multiple pages at once and automatically organizes and stores the order. By automatically recognizing the page order of a manual and storing digital data in the correct order, subsequent analysis becomes easier. Some or all of the above-mentioned processes in the scanning unit may be performed using AI, or may be performed without using AI. For example, the scanning unit may input scanned page data into a generative AI, and the generative AI may perform recognition of page order. Specifically, when scanning multiple pages of a manual in bulk, the scanning unit splits each page image tensor (e.g., 600 dpi, 2480×3508×3 RGB image) by page, and extracts page numbers and header/footer position and font features using an image recognition module (e.g., convolutional neural network). Even when page numbers are missing or there are misbound or missing pages, the scanning unit analyzes text features of page content (e.g., chapter titles, headings, paragraph structure) and the order of appearance of figures and tables using a natural language processing module (e.g., Transformer-based large language model), and estimates the logical page order. Examples of AI input include: (1) “array of manual page image tensors”, (2) “OCR text data for each page”, (3) “position information of candidate page numbers”, etc. Examples of AI output include: (1) “reordering index sequence for page order (e.g., [3,1,2,4])”, (2) “confidence score for each page (e.g., ‘Page 1:0.99, Page 2:0.95’)”, (3) “warning label for pages with unknown order”, etc. Based on the AI output, the scanning unit saves image data and text data in the correct order and seamlessly passes the data to the subsequent analysis unit. As a subsequent process, the ordered data is used as input for assembly procedure generation AI or figure-text correspondence AI, preventing analysis errors or erroneous assembly procedure generation due to incorrect page order. These processes realize high-precision and high-speed automatic recognition of page order for large numbers of pages, which is difficult with human visual confirmation or manual reordering, through multi-layered integration of image, text, and structural information. The technical effects are: (1) significant reduction in work time through complete automation of page order recognition; (2) significant reduction of analysis errors due to order mistakes; (3) flexible response to missing page numbers or misbound pages; and (4) improved adaptability to various manual formats. Specific application fields include digitization of multi-page manuals for home appliances, furniture, and industrial equipment; manual management on factory production lines; and electronic conversion of medical device procedure manuals. Through these technical details, the present invention goes beyond mere automation of human work and brings about improvements in computer technology itself.

The robot arm is capable of estimating the user's emotion and adjusting the operation speed of the robot arm based on the estimated emotion. For example, if the user is anxious, the robot arm increases its operation speed. If the user is relaxed, the robot arm slows down its operation speed. If the user feels uneasy, the robot arm adjusts its operation speed to make the user feel at ease. By adjusting the operation speed of the robot arm according to the user's emotion, more appropriate operation becomes possible. Emotion estimation is realized using, for example, an emotion engine or generative AI with emotion estimation functions. Generative AI may be a text generation AI (e.g., LLM) or a multimodal generative AI, but is not limited to these examples. Some or all of the above-mentioned processes in the robot arm may be performed using AI, or may be performed without using AI. For example, the robot arm may input the user's emotion data into a generative AI, and the generative AI may perform emotion estimation. Specifically, the robot arm inputs multiple modality data such as the user's face image tensor (e.g., 128×128×3), voice waveform data (e.g., 3 seconds of audio samples), and biometric sensor values (e.g., heart rate, skin potential, respiration rate) into an emotion recognition AI (e.g., multimodal emotion recognition model, ResNet-based image feature extraction+Transformer-based integration model). The robot arm integrates image features (e.g., facial action unit vectors), voice features (e.g., MFCC, pitch, spectral energy), and biometric features (e.g., heart rate variability, skin potential changes), and outputs emotion labels (e.g., ‘anxiety’, ‘relaxation’, ‘uneasiness’) and emotion scores (e.g., ‘anxiety:0.7, relaxation:0.2, uneasiness:0.1’). Examples of AI input include: (1) “face image tensor 128×128×3”, (2) “voice waveform data (3 seconds)”, (3) “biometric sensor value vector (heart rate, skin potential)”, etc. Examples of AI output include: (1) “emotion label (e.g., ‘anxiety’)”, (2) “emotion score distribution (e.g., ‘anxiety:0.8, relaxation:0.1, uneasiness:0.1’)”, (3) “estimation confidence (e.g., 0.95)”, etc. Based on the AI output, the robot arm automatically adjusts operation speed parameters (e.g., joint angular velocity, acceleration, interval between operations). For example, if the user is anxious, the robot arm sets the joint angular velocity to 1.5 times the normal value and shortens the work cycle time. If the user is relaxed, the robot arm suppresses operation speed to 0.7 times and prioritizes smoothness and safety of operation. If the user feels uneasy, the robot arm gradually adjusts operation speed and may provide warnings by voice or light before starting operation to enhance the user's sense of security. As a subsequent process, the robot arm feeds back the result of operation speed adjustment to the control unit or user interface, and the user is presented with the current operation mode and speed. These processes realize high-precision and high-speed control of operation speed according to the user's psychological state, which is difficult with human subjective judgment or simple rule-based methods, through multi-layered feature extraction and decision-making algorithms of AI. The technical effects are: (1) flexible control of operation speed according to user psychology; (2) compatibility of work efficiency and safety; (3) reduction of user stress and risk of erroneous operation; and (4) enhanced adaptability to diverse user characteristics. Specific application fields include assembly support robots for home furniture, worker psychology-adaptive robots on factory production lines, assembly support for medical devices, and emergency equipment installation support at disaster sites. Through these technical details, the present invention goes beyond mere automation of human work and brings about improvements in computer technology itself.

The control unit is capable of cooperating with other automation systems and controlling multiple tasks simultaneously. For example, the control unit cooperates with other automation systems and controls multiple tasks simultaneously. The control unit achieves efficient work. The control unit monitors the progress of work in real time. By cooperating with other automation systems and controlling multiple tasks simultaneously, work efficiency is improved. Some or all of the above-mentioned processes in the control unit may be performed using AI, or may be performed without using AI. For example, the control unit may input data from other automation systems into a generative AI, and the generative AI may perform cooperation and control. Specifically, the control unit collects real-time status data (e.g., work progress, error occurrence status, part inventory, transport route information, etc.) from multiple robot arms, transport devices, inspection devices, and other automation systems in a factory. The control unit integrates these diverse system data and inputs them into an AI (e.g., multi-agent reinforcement learning model or graph neural network). Examples of AI input include: (1) “state vector of each automation system (e.g., progress rate, operating status, error code)”, (2) “work schedule data”, (3) “resource allocation information”, etc. Examples of AI output include: (1) “work assignment optimization results (e.g., task instruction list for each robot)”, (2) “progress monitoring alerts (e.g., delay detection, bottleneck warning)”, (3) “cooperation control parameters (e.g., timing adjustment, priority setting)”, etc. Based on the AI output, the control unit automatically adjusts work assignment and timing among multiple automation systems to maximize overall work efficiency and throughput. Furthermore, in case of progress or abnormality occurrence, the control unit resets control parameters in real time to achieve flexible cooperation control. As a subsequent process, the result of cooperation control is fed back to each automation system or higher-level management system, maintaining overall optimization. These processes realize high-precision and high-speed cooperation among large-scale and complex systems, which are difficult with manual work or simple rule-based methods, through multi-layered feature extraction and decision-making algorithms of AI. The technical effects are: (1) significant improvement in work efficiency and throughput through cooperation among multiple automation systems; (2) real-time monitoring of progress and response to abnormalities; (3) cost reduction through resource optimization; and (4) flexible adaptation to various production lines and work environments. Specific application fields include overall control of factory production lines, automatic transport and sorting in logistics warehouses, multi-device cooperation control of medical equipment, and cooperative work of multiple robots at disaster sites. Through these technical details, the present invention brings about improvements in computer technology.

The scanning unit is capable of estimating the user's emotion and adjusting the scanning resolution based on the estimated emotion. For example, if the user is anxious, the scanning unit performs rapid scanning at low resolution. If the user is relaxed, the scanning unit performs careful scanning at high resolution. If the user feels uneasy, the scanning unit performs balanced scanning at medium resolution. By adjusting the scanning resolution according to the user's emotion, more appropriate scanning becomes possible. Emotion estimation is realized using, for example, an emotion engine or generative AI with emotion estimation functions. Generative AI may be a text generation AI (e.g., LLM) or a multimodal generative AI, but is not limited to these examples. Some or all of the above-mentioned processes in the scanning unit may be performed using AI, or may be performed without using AI. For example, the scanning unit may input the user's emotion data into a generative AI, and the generative AI may perform emotion estimation. Specifically, the scanning unit inputs multiple modalities such as the user's facial image (e.g., face image tensor 128×128×3), audio data (e.g., 3 seconds of audio waveform), and biometric sensor data (e.g., heart rate, skin potential) into an emotion estimation AI (e.g., multimodal emotion recognition model). The AI integrates image features (e.g., facial action unit vectors), audio features (e.g., MFCC, pitch), and biometric features (e.g., heart rate variability), and outputs emotion labels (e.g., ‘anxiety’, ‘relaxation’, ‘uneasiness’) and emotion scores (e.g., ‘anxiety:0.8, relaxation:0.1, uneasiness:0.1’). Examples of AI input include: (1) “face image tensor”, (2) “audio waveform data”, (3) “biometric sensor values”, etc. Examples of AI output include: (1) “emotion label”, (2) “emotion score distribution”, (3) “estimation confidence”, etc. Based on the AI output, the scanning unit automatically adjusts the scanning resolution (e.g., 200 dpi, 600 dpi, 1200 dpi, etc.) to achieve optimal scan quality and speed according to the user's psychological state. As a subsequent process, the result of scanning resolution adjustment is fed back to the user interface, improving user comfort and work efficiency. These processes realize objective and quantitative estimation of emotional state and optimization of scanning operation based on it, which are difficult with human subjective judgment. The technical effects include: (1) flexible control of scan quality according to user psychology; (2) reduction of scanning errors and user stress; and (3) improved adaptability to diverse user characteristics. Application fields include home scanners, work support in factories, and digitization of records in medical settings. Through these technical details, the present invention brings about improvements in computer technology.

The robot arm is capable of automatically detecting the shape and material of parts during operation and selecting the optimal assembly method. For example, the robot arm detects the shape of a part and selects the optimal assembly method. The robot arm detects the material of a part and selects the optimal assembly method. The robot arm detects both the shape and material of a part and selects the optimal assembly method. By selecting the optimal assembly method according to the shape and material of the parts, assembly accuracy is improved. Some or all of the above-mentioned processes in the robot arm may be performed using AI, or may be performed without using AI. For example, the robot arm may input data on the shape and material of parts into a generative AI, and the generative AI may select the optimal assembly method. Specifically, at the start of assembly work, the robot arm scans the outline of a part using a vision sensor (e.g., 3D camera, RGB-D camera), and extracts shape feature quantities (e.g., point cloud data, contour vectors, volume/surface area parameters) using an image recognition AI (e.g., U-Net-based segmentation model or ResNet-based classification model). Furthermore, the robot arm inputs physical property data such as reflection spectra obtained from near-infrared spectroscopic sensors or tactile sensors, and hardness or elasticity values, into the AI to infer material classification (e.g., metal, resin, wood, rubber, etc.). Examples of AI input include: (1) “3D point cloud data of parts (e.g., an array of 100,000 [x, y, z] points)”, (2) “surface image tensor (e.g., 128×128×3)”, (3) “spectral reflection vector”, etc. Examples of AI output include: (1) “shape label (e.g., ‘cylinder’, ‘L-shape’, ‘plate’)”, (2) “material label (e.g., ‘aluminum’, ‘ABS resin’, ‘MDF’)”, (3) “recommended assembly method parameters (e.g., gripping point coordinates, fastening force, type of adhesive)”, etc. Based on the AI output, the robot arm automatically selects the gripping force of the servo motor and the type of end effector (e.g., suction pad, gripper, magnetic chuck), and executes the optimal assembly operation for each part (e.g., screwing, press-fitting, insertion, adhesion). As a subsequent process, after assembly is completed, the robot arm rechecks the assembly state using a vision sensor or force sensor, and performs automatic correction if any abnormality is detected. These processes greatly surpass conventional technology in that the AI autonomously performs integrated analysis of high-dimensional feature quantities and assembly optimization for each part, which is difficult with human heuristics or visual inspection. The technical effects are: (1) significant improvement in work accuracy and quality through automatic optimization of assembly methods according to part shape and material; (2) flexible response to various part variations; (3) reduction of assembly errors and part damage; and (4) continuous improvement of accuracy through accumulation of work history. Specific application fields include multi-variety assembly of home appliances, furniture, and industrial equipment; precision assembly of medical devices; assembly of aerospace parts with different materials; and temporary facility construction at disaster sites. Through these technical details, the present invention goes beyond mere automation of human work and brings about improvements in computer technology itself.

The analysis unit is capable of comparing the content of a manual with other related documents during analysis and extracting differences and commonalities. For example, the analysis unit compares the content of a manual with other related documents and extracts differences. The analysis unit compares the content of a manual with other related documents and extracts commonalities. The analysis unit compares the content of a manual with other related documents and extracts both differences and commonalities. By comparing the content of a manual with other related documents and extracting differences and commonalities, analysis accuracy is improved. Some or all of the above-mentioned processes in the analysis unit may be performed using AI, or may be performed without using AI. For example, the analysis unit may input the content of a manual and data of other related documents into a generative AI, and the generative AI may perform comparison and extraction. Specifically, the analysis unit inputs instruction manual text data obtained from the scanning unit (e.g., token sequence, text blocks for each chapter/item) and comparison target documents obtained from a related document database (e.g., previous versions, competitor product manuals, specification sheets, etc.) into a natural language processing AI (e.g., Transformer-based multi-document comparison model). Examples of AI input include: (1) “instruction manual text token sequence”, (2) “comparison target document token sequence”, (3) “comparison target segment index”, etc. Examples of AI output include: (1) “list of differences (e.g., added/deleted/changed steps)”, (2) “list of commonalities (e.g., identical steps, identical part descriptions)”, (3) “difference highlighting index”, etc. Based on the AI output, the analysis unit visualizes the differences between the manual and related documents, and extracts important changes and common procedures as structured data. As a subsequent process, the robot arm control unit or user interface refers to the difference information, highlights changes in work procedures, and utilizes common procedures for automated processing. These processes realize high-precision extraction of differences between large-scale and complex documents, which is difficult with manual work or simple full-text comparison, through multi-layered feature extraction and semantic comparison capabilities of AI. The technical effects are: (1) prevention of work errors through automatic extraction of differences and commonalities between documents; (2) efficient confirmation of version management and specification compliance; (3) improved accuracy of subsequent automated processing; and (4) flexible response to various document formats. Specific application fields include manual version management for home appliances, furniture, and industrial equipment; management of work procedure changes in factories; and confirmation of specification compliance for medical devices. Through these technical details, the present invention brings about improvements in computer technology.

The control unit is capable of estimating the user's emotion and adjusting the control algorithm based on the estimated emotion. For example, if the user is anxious, the control unit applies a control algorithm that prioritizes rapid operation. If the user is relaxed, the control unit applies a control algorithm that prioritizes careful operation. If the user feels uneasy, the control unit applies a control algorithm that prioritizes safety. By adjusting the control algorithm according to the user's emotion, more appropriate control becomes possible. Emotion estimation is realized using, for example, an emotion engine or generative AI with emotion estimation functions. Generative AI may be a text generation AI (e.g., LLM) or a multimodal generative AI, but is not limited to these examples. Some or all of the above-mentioned processes in the control unit may be performed using AI, or may be performed without using AI. For example, the control unit may input the user's emotion data into a generative AI, and the generative AI may perform emotion estimation. Specifically, the control unit inputs multiple modality data such as face image tensor (e.g., 128×128×3), voice waveform data (e.g., 3 seconds of audio samples), and biometric sensor values (e.g., heart rate, skin potential, respiration rate) into an emotion recognition AI (e.g., multimodal emotion recognition model, ResNet-based image feature extraction+Transformer-based integration model). The control unit integrates image features (e.g., facial action unit vectors), voice features (e.g., MFCC, pitch, spectral energy), and biometric features (e.g., heart rate variability, skin potential changes), and outputs emotion labels (e.g., ‘anxiety’, ‘relaxation’, ‘uneasiness’) and emotion scores (e.g., ‘anxiety:0.7, relaxation:0.2, uneasiness:0.1’). Examples of AI input include: (1) “face image tensor 128×128×3”, (2) “voice waveform data (3 seconds)”, (3) “biometric sensor value vector (heart rate, skin potential)”, etc. Examples of AI output include: (1) “emotion label (e.g., ‘anxiety’)”, (2) “emotion score distribution (e.g., ‘anxiety:0.8, relaxation:0.1, uneasiness:0.1’)”, (3) “estimation confidence (e.g., 0.95)”, etc. Based on the AI output, the control unit automatically switches the selection of control algorithms and parameters (e.g., PID control gain, operation speed, acceleration limit, error tolerance). For example, if the user is anxious, the control unit applies a high-speed response feedforward control or predictive control algorithm to minimize operation delay. If the user is relaxed, the control unit applies feedback control or fine position correction algorithms that emphasize smoothness and precision of operation. If the user feels uneasy, the control unit prioritizes safety, tightens abnormality detection thresholds, suppresses operation speed, and adds redundant safety confirmation procedures. As a subsequent process, the result of control algorithm switching is fed back to the robot arm or user interface, and the user is presented with the current control mode and safety status. These processes realize high-precision and high-speed dynamic optimization of control algorithms according to the user's psychological state, which is difficult with human subjective judgment or simple rule-based methods, through multi-layered feature extraction and decision-making algorithms of AI. The technical effects are: (1) flexible switching of control algorithms according to user psychology; (2) compatibility of work efficiency and safety; (3) reduction of user stress and risk of erroneous operation; and (4) enhanced adaptability to diverse user characteristics. Specific application fields include assembly support robots for home furniture, worker psychology-adaptive control on factory production lines, safety control of medical devices, and emergency equipment installation support at disaster sites. Through these technical details, the present invention goes beyond mere automation of human work and brings about improvements in computer technology itself.

The robot arm can automatically adjust the contact pressure of parts during operation of the robot arm and prevent damage. For example, the contact pressure of parts is detected to prevent damage. The contact pressure of parts is automatically adjusted to prevent damage. The contact pressure of parts is adjusted in real time to prevent damage. By automatically adjusting the contact pressure of parts, damage is prevented and assembly accuracy is improved. Some or all of the above-mentioned processes in the robot arm may be performed using AI, or may be performed without using AI. For example, the robot arm can input contact pressure data of parts into a generative AI and have the generative AI execute the adjustment of contact pressure. Specifically, the robot arm acquires real-time contact pressure data (e.g., pressing force in Newtons, fastening torque) from a six-axis force sensor or torque sensor built into the end effector, and inputs it into a force control AI (e.g., reinforcement learning-based force control model or decision tree regression model). Examples of input to the AI include: (1) “contact pressure time-series data (e.g., 100 samples×1 dimension)”, (2) “part material label (e.g., ‘aluminum’, ‘resin’)”, (3) “work history vector”, and so on. Examples of output from the AI include: (1) “optimal contact pressure value (e.g., 2.5N)”, (2) “pressure adjustment parameters (e.g., pressing speed, fastening torque)”, (3) “damage risk warning flag”, and so on. The robot arm automatically adjusts the control gain of the servo motor or end effector based on the AI output to maintain optimal contact pressure for each part. Furthermore, if abnormal pressure fluctuations or damage risks are detected during assembly operation, the robot arm immediately stops operation and automatically executes corrective actions such as re-gripping or re-positioning. As a subsequent process, the results of contact pressure adjustment and abnormality detection history are fed back to the control unit or user interface, thereby improving work quality and safety. These processes realize high-precision and high-speed pressure control and damage prevention, which are difficult with human senses or empirical rules, by integrating AI and sensor feedback. The technical effects are that the robot arm achieves: (1) significant reduction of part damage by automatic optimization of contact pressure; (2) flexible adaptation to various materials and shapes; (3) both assembly quality and work efficiency; and (4) continuous improvement of accuracy by accumulating work history. Specific application fields include assembly of precision equipment, damage prevention assembly of medical devices, multi-material assembly of home appliances and furniture, and high-reliability assembly of aerospace parts. With these technical details, the present invention goes beyond mere automation of human work and brings about improvement of computer technology itself.

The analysis unit can, during analysis, compare the content of the manual with a cloud database and reflect the latest information. For example, the content of the manual is compared with the cloud database and the latest information is reflected. The content of the manual is compared with the cloud database and update information is reflected. The content of the manual is compared with the cloud database and the latest technical information is reflected. By comparing the content of the manual with the cloud database and reflecting the latest information, the accuracy of analysis is improved. Some or all of the above-mentioned processes in the analysis unit may be performed using AI, or may be performed without using AI. For example, the analysis unit can input the content of the manual and data from the cloud database into a generative AI and have the generative AI execute the comparison and reflection of information. Specifically, the analysis unit links the manual text data obtained from the scanning unit (e.g., token sequences, text blocks for each chapter or item) with a cloud-based technical information database (e.g., latest product specifications, parts lists, work procedures, regulatory information, etc.) via API, and inputs them into a natural language processing AI (e.g., Transformer-based knowledge integration model). Examples of input to the AI include: (1) “manual text token sequence”, (2) “latest information token sequence obtained from the cloud database”, (3) “update history index”, and so on. Examples of output from the AI include: (1) “difference list between manual content and latest information”, (2) “automatically updated text reflecting update locations”, (3) “technical information reliability score”, and so on. The analysis unit automatically corrects and updates the manual content with the latest technical information based on the AI output, thereby reducing the risk of proceeding with work based on incorrect procedures or outdated specifications. As a subsequent process, the robot arm control unit or user interface refers to the analysis results reflecting the latest information to prevent errors in work procedures or parts selection. These processes realize high-precision and high-speed real-time response to large-scale and frequent information updates, which are difficult with manual work or manual updates, by integrating AI and cloud collaboration. The technical effects are that the analysis unit achieves: (1) prevention of work mistakes by automatic reflection of the latest information; (2) rapid response to regulatory and product specification changes; (3) improvement of accuracy in subsequent automated processing; and (4) flexible adaptation to various information sources. Specific application fields include automatic updating of manuals for home appliances, furniture, and industrial equipment, updating of work procedures in factories, and regulatory compliance for medical devices. With these technical details, the present invention brings about improvement of computer technology.

Below, the processing flow of Example of the Embodiment will be briefly described. Specifically, the processing flow in Example of the present invention is composed of a highly advanced automation process that multilayeredly integrates multiple AI, sensor, and control technologies, including: digitization of manual pages by the scanning unit using a high-resolution image sensor and image preprocessing circuit; integrated analysis of diagrams, text, and procedures by the analysis unit using a combination of image recognition AI (e.g., convolutional neural networks) and natural language processing AI (e.g., Transformer-based large language models); automation of wiring and assembly work by the robot arm using multi-joint servo motors and end effectors; and provision of time-series recording of operation history, automatic correction by anomaly detection AI, parameter optimization, cooperation with other automation systems, and remote operation interface by the control unit. The system inputs various data such as image tensors, text token sequences, sensor data, and work history into AI, generates structured outputs such as assembly procedures, operation patterns, anomaly detection, optimization parameters, and cooperative control instructions, and links each module in real time. As a result, the system realizes high-precision and high-efficiency execution of complex assembly, wiring, anomaly correction, multi-system cooperation, and user psychology-adaptive control, which were conventionally difficult, going beyond simple human automation. The technical effects include: (1) significant reduction of work time; (2) reduction of misassembly and erroneous operation; (3) flexible adaptation to various manuals, parts, and work environments; (4) continuous improvement of accuracy by accumulating work history; and (5) improved scalability through remote operation and cloud collaboration. Specific application fields include automatic assembly of household furniture, production lines in factories, assembly support for medical devices, emergency equipment installation at disaster sites, and remote work support in space and marine fields. With these technical details, the present invention brings about improvement of computer technology itself and has novelty and inventive step beyond mere automation of human work.

Step 1: The scanning unit scans each page of the manual and stores it as digital data. The scanning unit uses a high-resolution scanner and is equipped with a function to adjust the scanning resolution and speed. For example, the scanning unit can automatically select optimal scanning settings according to the paper quality and printing condition of the manual. Step 2: The analysis unit analyzes the data scanned by the scanning unit and generates wiring or furniture assembly procedures. The analysis unit analyzes the content of the manual using image recognition technology and natural language processing, recognizes drawings and illustrations, and links them with text. Step 3: The robot arm performs wiring or furniture assembly based on the procedures generated by the analysis unit. The robot arm is equipped with a connection unit for connecting wiring and an assembly unit for assembling furniture parts, and automates these tasks. Step 4: The control unit controls the operation of the robot arm. The control unit records the operation history of the robot arm and reflects it in the next operation. In addition, the control unit is equipped with a function to detect abnormalities during operation of the robot arm and automatically correct them. Specifically, in each step of Example of the present invention, the scanning unit automatically sets optimal scanning parameters (e.g., resolution, exposure time, contrast correction value) using a high-resolution image sensor and paper quality/printing condition sensor, and generates manual image tensors (e.g., 600 dpi, 2480×3508×3). The analysis unit detects drawings, illustrations, part numbers, and wiring routes using image recognition AI (e.g., YOLOv5 or ResNet, etc.), tokenizes and semantically analyzes text using natural language processing AI (e.g., Transformer-based large language models), and generates correspondence between diagrams and text and logical structure of assembly procedures (e.g., directed graph format). The robot arm, equipped with a multi-joint structure with six or more degrees of freedom and end effectors (grippers for wiring, effectors for gripping and fastening parts), sequentially executes gripping, moving, connecting, and fastening of each part according to procedure data (e.g., action list in JSON format) received from the analysis unit. The control unit records joint angles, torque, force, and vision sensor data of the robot arm in time series, applies automatic correction procedures using anomaly detection AI (e.g., LSTM-based time-series anomaly detection model) when errors occur, and analyzes operation history to optimize parameters for improving work efficiency in subsequent operations. Through this series of processes, the system integrates image, text, and sensor information multilayeredly, going beyond simple human automation, and realizes high-precision and high-efficiency execution of complex assembly work that was conventionally difficult for manual labor. The technical effects include: (1) significant reduction of work time by automating assembly procedure generation; (2) prevention of misassembly and reduction of work mistakes by AI; (3) flexible adaptation to various manuals, parts, and wiring patterns; (4) continuous improvement of accuracy by accumulating work history; and (5) improved scalability through remote work instructions and cloud collaboration. Specific application fields include automatic assembly of household furniture, automation of wiring work on factory production lines, assembly support for medical devices, and emergency equipment installation at disaster sites. With these technical details, the present invention brings about improvement of computer technology itself and has novelty and inventive step beyond mere automation of human work.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the above-described elements, including the scanning unit, analysis unit, robot arm, and control unit, is implemented by at least one of, for example, a smart device 14 and a data processing apparatus 12. For example, the scanning unit scans each page of a manual using a camera 42 of the smart device 14 and stores it as digital data. The analysis unit is implemented, for example, by a specific processing unit 290 of the data processing apparatus 12, and analyzes the scanned data to generate wiring or furniture assembly procedures. The robot arm is controlled, for example, by a control unit 46A of the smart device 14 and performs wiring or furniture assembly based on the generated procedures. The control unit is implemented, for example, by a specific processing unit 290 of the data processing apparatus 12 and controls the operation of the robot arm. The correspondence between each unit and the device or control unit is not limited to the above examples and various modifications are possible.

### Second Embodiment

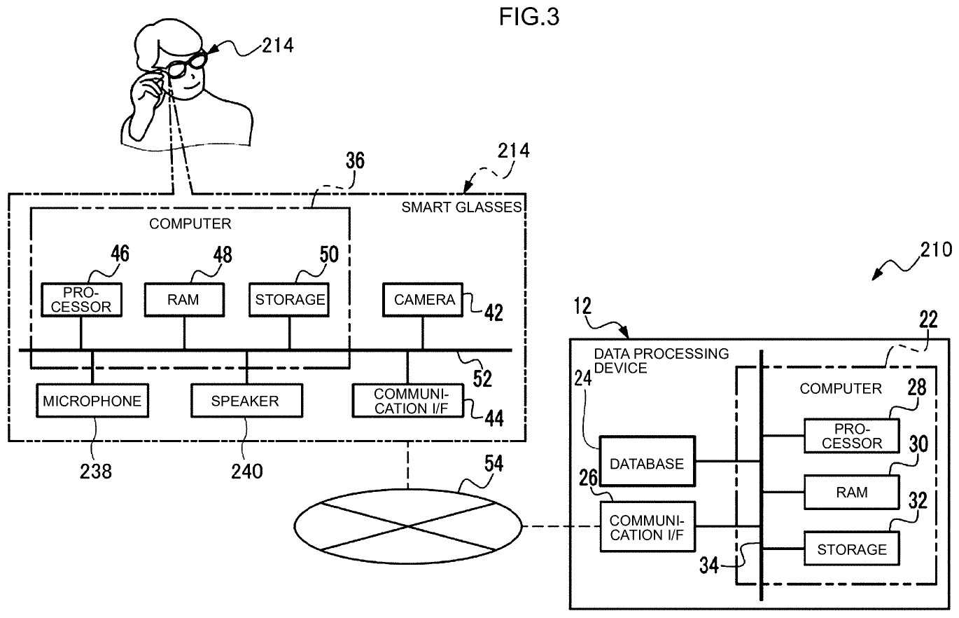

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

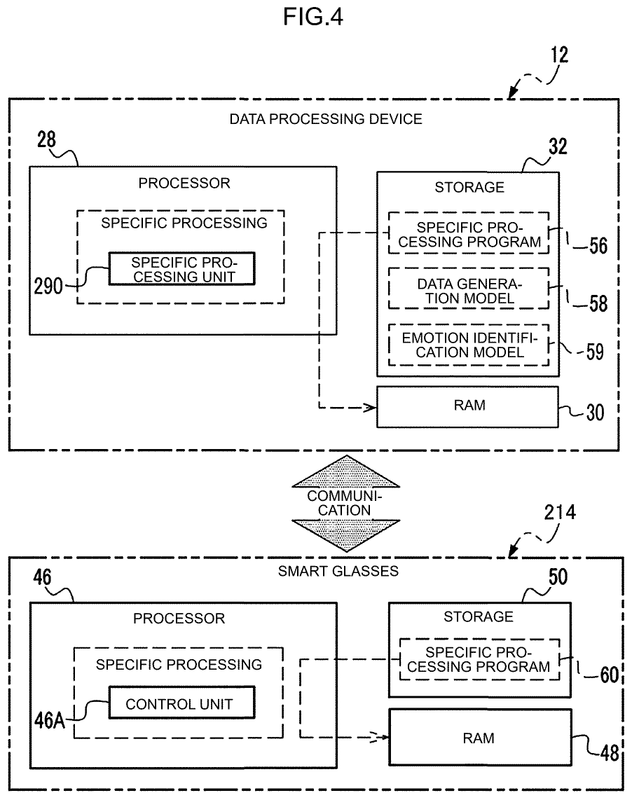

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the above-described elements, including the scanning unit, analysis unit, robot arm, and control unit, is implemented by at least one of, for example, smart glasses 214 and a data processing apparatus 12. For example, the scanning unit scans each page of a manual using a camera 42 of the smart glasses 214 and stores it as digital data. The analysis unit is implemented, for example, by a specific processing unit 290 of the data processing apparatus 12, and analyzes the scanned data to generate wiring or furniture assembly procedures. The robot arm is controlled, for example, by a control unit 46A of the smart glasses 214 and performs wiring or furniture assembly based on the generated procedures. The control unit is implemented, for example, by a specific processing unit 290 of the data processing apparatus 12 and controls the operation of the robot arm. The correspondence between each unit and the device or control unit is not limited to the above examples and various modifications are possible.

### Third Embodiment

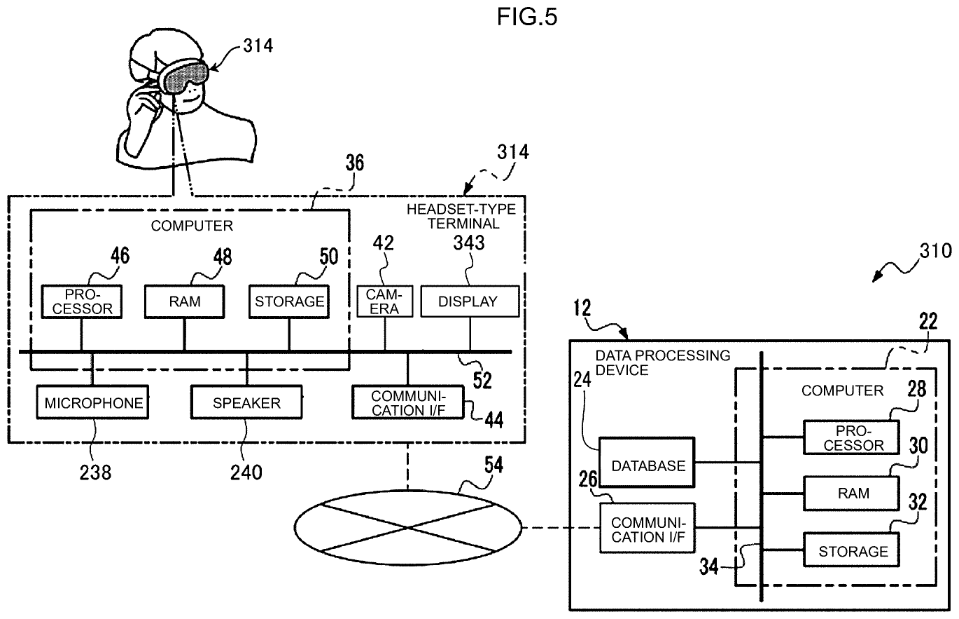

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

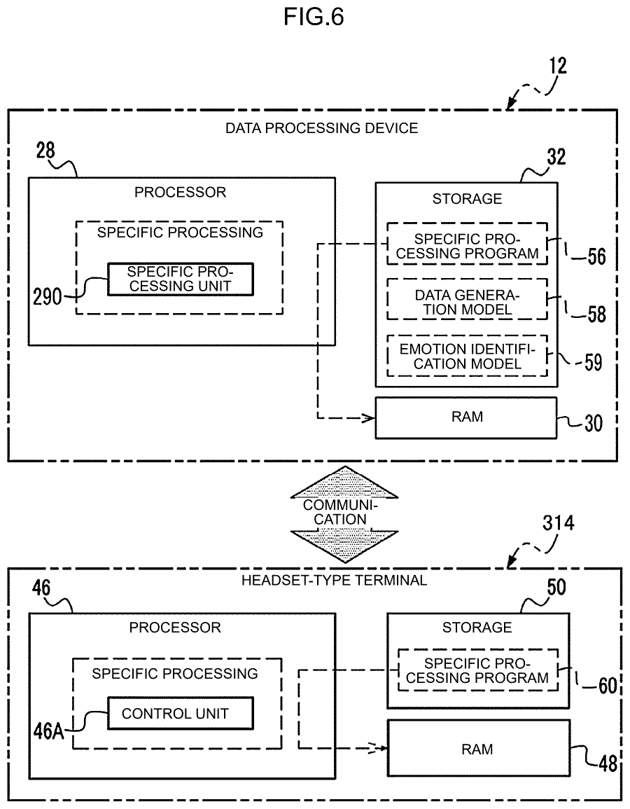

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the above-described elements, including the scanning unit, analysis unit, robot arm, and control unit, is implemented by at least one of, for example, a headset-type terminal 314 and a data processing apparatus 12. For example, the scanning unit scans each page of a manual using a camera 42 of the headset-type terminal 314 and stores it as digital data. The analysis unit is implemented, for example, by a specific processing unit 290 of the data processing apparatus 12, and analyzes the scanned data to generate wiring or furniture assembly procedures. The robot arm is controlled, for example, by a control unit 46A of the headset-type terminal 314 and performs wiring or furniture assembly based on the generated procedures. The control unit is implemented, for example, by a specific processing unit 290 of the data processing apparatus 12 and controls the operation of the robot arm. The correspondence between each unit and the device or control unit is not limited to the above examples and various modifications are possible.

### Fourth Embodiment

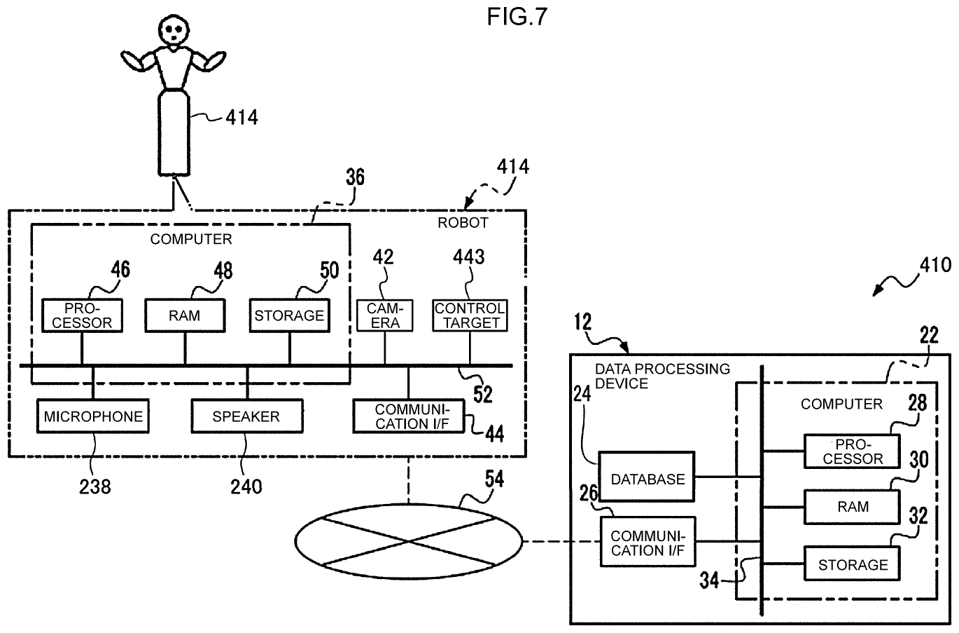

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

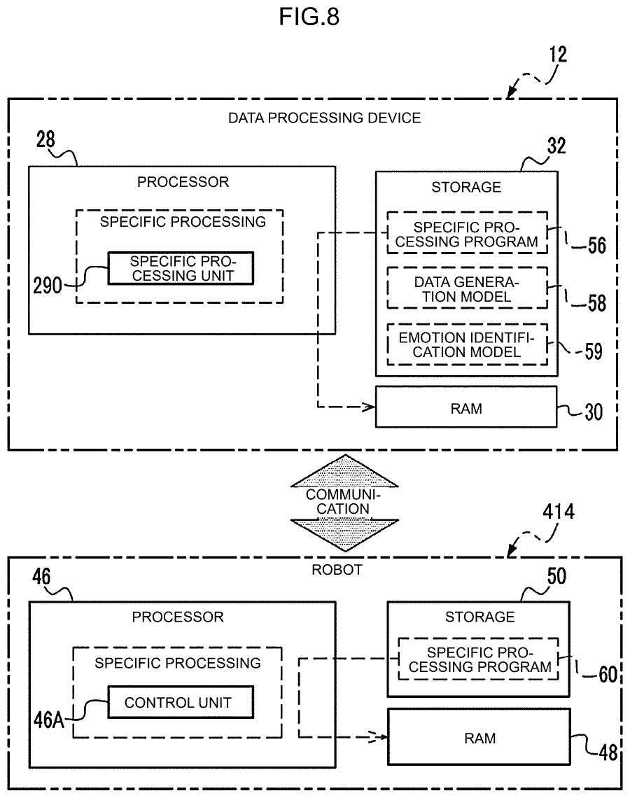

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the above-described elements, including the scanning unit, analysis unit, robot arm, and control unit, is implemented by at least one of, for example, a robot 414 and a data processing apparatus 12. For example, the scanning unit scans each page of a manual using a camera 42 of the robot 414 and stores it as digital data. The analysis unit is implemented, for example, by a specific processing unit 290 of the data processing apparatus 12, and analyzes the scanned data to generate wiring or furniture assembly procedures. The robot arm is controlled, for example, by a control unit 46A of the robot 414 and performs wiring or furniture assembly based on the generated procedures. The control unit is implemented, for example, by a specific processing unit 290 of the data processing apparatus 12 and controls the operation of the robot arm. The correspondence between each unit and the device or control unit is not limited to the above examples and various modifications are possible.

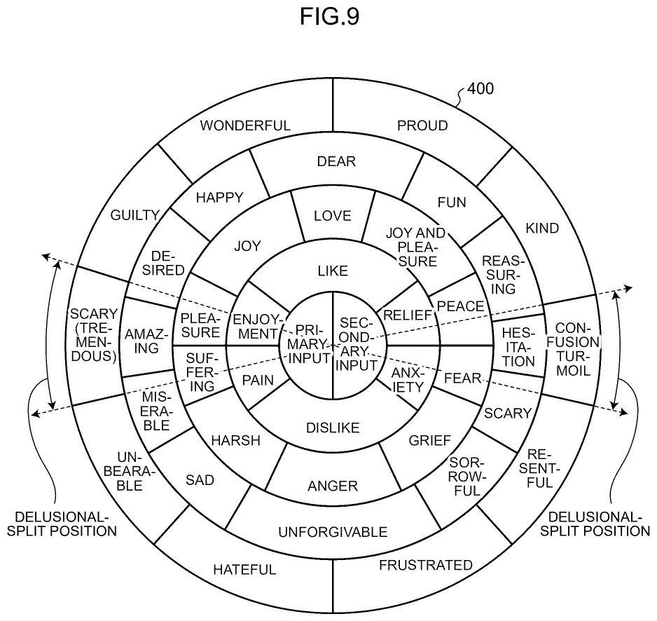

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

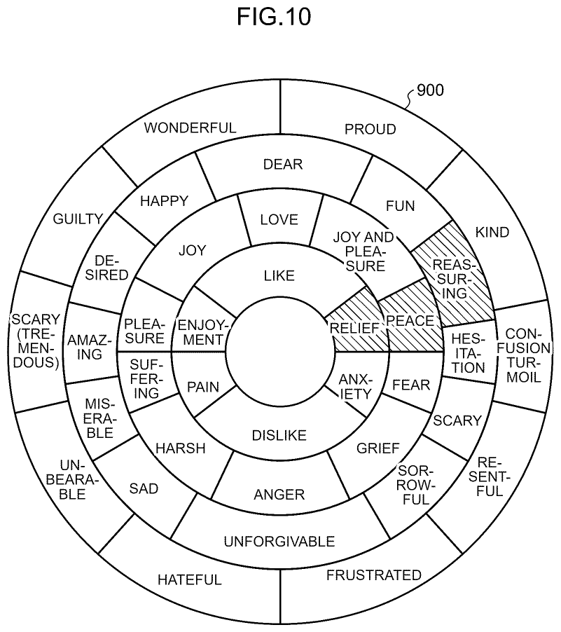

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a scanning unit configured to scan each page of a manual and store it as digital data; an analysis unit configured to analyze data scanned by the scanning unit and generate wiring or furniture assembly procedures; a robot arm configured to perform wiring or furniture assembly based on the procedures generated by the analysis unit; and a control unit configured to control the operation of the robot arm.
(Supplementary Note 2) The system according to Supplementary Note 1, wherein the analysis unit analyzes the content of the manual using image recognition technology and natural language processing.
(Supplementary Note 3) The system according to Supplementary Note 1, wherein the robot arm comprises a connection unit configured to connect wiring.
(Supplementary Note 4) The system according to Supplementary Note 1, wherein the robot arm comprises an assembly unit configured to assemble furniture parts.
(Supplementary Note 5) The system according to Supplementary Note 1, wherein the control unit is configured to control the operation of the robot arm.
(Supplementary Note 6) The system according to Supplementary Note 1, wherein the scanning unit describes a specific method for estimating a user's emotion and adjusting the timing of scanning based on the estimated emotion of the user.
(Supplementary Note 7) The system according to Supplementary Note 1, wherein the scanning unit automatically recognizes the page order of the manual during scanning and stores the digital data in the correct order.
(Supplementary Note 8) The system according to Supplementary Note 1, wherein the scanning unit detects the paper quality and printing condition of the manual during scanning and automatically selects appropriate scanning settings.
(Supplementary Note 9) The system according to Supplementary Note 1, wherein the scanning unit describes a specific method for estimating a user's emotion and adjusting the scanning resolution based on the estimated emotion of the user.
(Supplementary Note 10) The system according to Supplementary Note 1, wherein the scanning unit automatically recognizes the language of the manual during scanning and selects appropriate language settings.
(Supplementary Note 11) The system according to Supplementary Note 1, wherein the scanning unit detects the size and shape of the manual during scanning and selects appropriate scanning methods.
(Supplementary Note 12) The system according to Supplementary Note 1, wherein the analysis unit describes a specific method for estimating a user's emotion and determining the priority of analysis based on the estimated emotion of the user.
(Supplementary Note 13) The system according to Supplementary Note 1, wherein the analysis unit segments the content of the manual during analysis and performs detailed analysis for each segment.
(Supplementary Note 14) The system according to Supplementary Note 1, wherein the analysis unit automatically recognizes drawings and illustrations in the manual during analysis and links them with text.
(Supplementary Note 15) The system according to Supplementary Note 1, wherein the analysis unit describes a specific method for estimating a user's emotion and adjusting the display method of analysis results based on the estimated emotion of the user.
(Supplementary Note 16) The system according to Supplementary Note 1, wherein the analysis unit compares the content of the manual with other related documents during analysis and extracts differences and commonalities.
(Supplementary Note 17) The system according to Supplementary Note 1, wherein the analysis unit matches the content of the manual with a cloud database during analysis and reflects the latest information.
(Supplementary Note 18) The system according to Supplementary Note 1, wherein the robot arm describes a specific method for estimating a user's emotion and adjusting the operation speed of the robot arm based on the estimated emotion of the user.
(Supplementary Note 19) The system according to Supplementary Note 1, wherein the robot arm automatically detects the shape and material of parts during operation and selects appropriate assembly methods.
(Supplementary Note 20) The system according to Supplementary Note 1, wherein the robot arm detects the position of parts in real time during operation and improves accuracy.
(Supplementary Note 21) The system according to Supplementary Note 1, wherein the robot arm describes a specific method for estimating a user's emotion and adjusting the operation order of the robot arm based on the estimated emotion of the user.
(Supplementary Note 22) The system according to Supplementary Note 1, wherein the robot arm detects the temperature and humidity of parts during operation and maintains an appropriate operating environment.
(Supplementary Note 23) The system according to Supplementary Note 1, wherein the robot arm automatically adjusts the contact pressure of parts during operation and prevents damage.
(Supplementary Note 24) The system according to Supplementary Note 1, wherein the control unit describes a specific method for estimating a user's emotion and adjusting control algorithms based on the estimated emotion of the user.
(Supplementary Note 25) The system according to Supplementary Note 1, wherein the control unit records the operation history of the robot arm and reflects it in the next operation.
(Supplementary Note 26) The system according to Supplementary Note 1, wherein the control unit is provided with a function to detect abnormalities during operation of the robot arm and automatically correct them.
(Supplementary Note 27) The system according to Supplementary Note 1, wherein the control unit describes a specific method for estimating a user's emotion and adjusting control parameters based on the estimated emotion of the user.
(Supplementary Note 28) The system according to Supplementary Note 1, wherein the control unit cooperates with other automation systems and controls multiple tasks simultaneously.
(Supplementary Note 29) The system according to Supplementary Note 1, wherein the control unit is provided with an interface capable of remotely operating the robot arm.

What is claimed is:

1. A system comprising:
circuitry configured to:
receive image data from an image sensor;
extract, using a convolutional neural network, feature vectors from the image data representing visual elements of a document;
generate, using a natural language processing model, sequence data based on the feature vectors;
transmit the sequence data to a controller configured to control a multi-joint robotic apparatus comprising a plurality of servo motors, an end effector, and at least one of a force sensor or a vision sensor; and
receive feedback data from the at least one of the force sensor or the vision sensor, and update the sequence data based on the feedback data.

2. The system according to claim 1,
wherein the document comprises a manual, and wherein the sequence data comprises assembly procedure data indicating an order of assembly operations.

3. The system according to claim 2,
wherein the assembly procedure data comprises at least one of wiring connection procedures or furniture part assembly procedures.

4. The system according to claim 1,
wherein the natural language processing model comprises a Transformer-based large language model configured to tokenize text extracted from the image data and perform semantic analysis to generate the sequence data.

5. The system according to claim 1,
wherein the convolutional neural network comprises at least one of a ResNet-based model or a YOLO-based object detection model configured to detect at least one of part drawings, wiring routes, illustrations, or symbols in the image data.

6. The system according to claim 1,
wherein the circuitry is further configured to extract image feature vectors having 2048 or more dimensions from the image data and text embedding vectors having 768 or more dimensions from text extracted from the image data, and to integrate the image feature vectors and the text embedding vectors to generate the sequence data as a directed graph structure.

7. The system according to claim 1,
wherein the end effector comprises at least one of a gripper, a suction pad, or a magnetic chuck, and wherein the controller is configured to select a type of the end effector based on a shape or material of a target part.

8. The system according to claim 1,
wherein the force sensor comprises a six-axis force torque sensor configured to measure contact pressure during an operation, and wherein the circuitry is further configured to adjust the sequence data based on the contact pressure to prevent damage to a target part.

9. The system according to claim 1,
wherein the vision sensor comprises at least one of a 3D camera, a depth sensor, or an RGB-D camera, and wherein the circuitry is further configured to estimate a position and orientation of a target part based on data from the vision sensor.

10. The system according to claim 1,
wherein the circuitry is further configured to detect an anomaly in the feedback data using a time-series anomaly detection model comprising an LSTM-based neural network, and to transmit corrective sequence data to the controller when the anomaly is detected.

11. The system according to claim 1,
wherein the circuitry is further configured to record operation history data comprising at least one of joint angles, torque values, or operation success flags, and to optimize the sequence data based on the operation history data.

12. The system according to claim 1,
wherein the image sensor comprises a CMOS image sensor, and wherein the circuitry is further configured to detect a paper quality and a printing condition of the document and to adjust image processing parameters based on the detected paper quality and printing condition.

13. The system according to claim 1,
wherein the circuitry is further configured to automatically recognize a page order of the document based on at least one of page numbers, header positions, or text content, and to process the image data in the recognized page order.

14. The system according to claim 1,
wherein the circuitry is further configured to identify a language of text in the image data using a multilingual Transformer model, and to select a language-specific natural language processing model based on the identified language.

15. The system according to claim 1, further comprising:
an emotion identification model stored in a memory, wherein the circuitry is further configured to estimate an emotion of a user by applying the emotion identification model to at least one of voice data, a face image, or biometric sensor data, and to adjust a processing priority based on the estimated emotion.

16. The system according to claim 15,
wherein the circuitry is further configured to adjust an operation speed of the multi-joint robotic apparatus based on the estimated emotion, such that when the estimated emotion indicates anxiety, the circuitry increases the operation speed, and when the estimated emotion indicates relaxation, the circuitry decreases the operation speed.

17. The system according to claim 1,
wherein the circuitry is further configured to cooperate with at least one additional automation system via a communication interface, and to coordinate operation timing between the multi-joint robotic apparatus and the at least one additional automation system.

18. A system comprising:
a communication interface configured to communicate with a client terminal via a packet-switched network conforming to at least one of a 5G, Wi-Fi, or Bluetooth communication standard;
a processor;
a random-access memory;
a memory storing a data generation model obtained by deep learning on a neural network, and an emotion identification model;
a database; and
circuitry configured to:
receive, from the client terminal via the communication interface, image data captured by a camera having a CMOS image sensor, the image data representing pages of a manual;
extract, using a convolutional neural network, feature vectors from the image data, the feature vectors representing at least one of part drawings, wiring routes, or assembly illustrations;
generate, using a natural language processing model comprising a Transformer architecture, assembly procedure data based on the feature vectors and text extracted from the image data;
estimate an emotion of a user by applying the emotion identification model to at least one of voice data captured by a microphone of the client terminal or biometric sensor data;
adjust at least one of a processing priority or a display method of the assembly procedure data based on the estimated emotion;
store the assembly procedure data in the database; and
transmit the assembly procedure data to a robot arm controller via the communication interface, the robot arm controller being configured to control a robot arm comprising a multi-joint structure with servo motors and an end effector to perform at least one of wiring connection or part assembly based on the assembly procedure data.

19. The system according to claim 18,
wherein the data generation model comprises at least one of a text generation AI, an image generation AI, or a multimodal generation AI, and wherein the data generation model is a fine-tuned model configured to output inference results from prompts without instructions.

20. A method performed by circuitry of a system, the method comprising:
receiving image data from an image sensor;
extracting, using a convolutional neural network, feature vectors from the image data representing visual elements of a document;
generating, using a natural language processing model, sequence data based on the feature vectors;
transmitting the sequence data to a controller configured to control a multi-joint robotic apparatus comprising a plurality of servo motors, an end effector, and at least one of a force sensor or a vision sensor; and
receiving feedback data from the at least one of the force sensor or the vision sensor, and updating the sequence data based on the feedback data.
